(19) United States
(12) Patent Application Publication
(10) Pub. No.: US 2006/0113231 A1
(43) Pub. Date: Jun. 1, 2006

(54) Sample pre-concentration tubes with sol-gel surface coatings and/or sol-gel monolithic beds

(76) Inventor: Abdul Malik, Tampa, FL (US)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/247,445

(22) Filed: Oct. 11, 2005

Related U.S. Application Data
(63) Continuation-in-part of application No. 10/710,212, filed on Jun. 25, 2004, now abandoned.
Application No. 10/710,212 is a division of application No. 10/001,489, filed on Oct. 23, 2001, now Pat. No. 6,783,680.
(60) Provisional application No. 60/242,534, filed on Oct. 23, 2000.

(51) Int. Cl. B01D 15/08

(52) U.S. Cl. 210/198.2; 96/101; 210/511; 96/234

(57) ABSTRACT

A method of pre-concentrating trace analytes is accomplished by extracting polar and non-polar analytes through a sol-gel coating. The sol-gel coating is either disposed on the inner surface of a capillary tube or disposed within the tube as a monolithic bed.

### CROSS-REFERENCE TO RELATED APPLICATIONS

This application is a continuation-in-part of co-pending U.S. Ser. No. 10/710,212, filed Jun. 25, 2004, which is a divisional of U.S. Ser. No. 10/001,489, filed on Oct. 23, 2001, now U.S. Pat. No. 6,783,680, which claims priority from U.S. Ser. No. 60/242,534, filed Oct. 23, 2000, which are all incorporated herein by reference in their entirety including any figures, tables, or drawings.

### FIELD OF THE INVENTION

The present invention relates to methods of analytical sample preparation for instrumental analysis. More specifically, the present invention relates to capillary microextraction techniques for pre-concentrating trace analytes and microextraction devices.

### BACKGROUND OF THE INVENTION

Sample preparation is an important step in chemical analysis, especially when dealing with traces of target analytes dispersed in complex matrices. Such matrices are commonplace in samples from environmental, petrochemical, and biological origins. Samples of this nature are not generally suitable for direct introduction into analytical instruments. Such incompatibility is related to two factors. First, the complex matrices may have a detrimental effect on the performance of the analytical system or they may interfere with the analysis of the target analytes. Second, the concentration of the target analytes in the sample may be so low that it goes beyond the detection limit of the analytical instrument. In both cases sample preparation is necessary to make the sample compatible with analytical instrumentation. This is achieved through sample clean-up and sample pre-concentration. Sample derivatization is also sometimes necessary to facilitate analysis and detection of target compounds.

Sample preparation in chemical analysis often involves various extraction techniques to isolate and pre-concentrate target compounds from complex matrices in which they exist in trace concentrations. Conventional extraction techniques (e.g., liquid-liquid extraction (Majors, R. E. LC*GC. Int. 1997, 10, 93-101), Soxhlet extraction (Lopez-Avila, V.; Bauer, K.; Milanes, J.; Beckert W. F. J. AOAC Int. 1993, 76, 864-880), etc.) frequently used for this purpose are often time-consuming and involve the use of large volumes of hazardous organic solvents.

To address environmental and health concerns associated with the use of large volumes of organic solvents and to reduce sample preparation time, newer extraction techniques have been developed that use either reduced amounts of organic solutes such as solid-phase extraction (SPE), (Coulibaly, K; Jeon L. J. Food Rev. Int. 1996, 12, 131-151), accelerated solvent extraction (ASE) (Richter, B. E.; Jones, B. A.; Ezzel, J. L.; Porter N. L.; Abdalovic N.; Pohi, C. Anal. Chem. 1996, 1033-1039), microwave-assisted solvent extraction (MASE) (Zlotorzynski, A. Crit. Rev. Anal. Chem. 1995, 25, 43-76), etc. Another approach to address these problems was to develop sample preparation techniques using alternative, less hazardous extraction media, such as supercritical fluid extraction (SFE) (Hawthorne, S. B.; Anal. Chem. 1990, 62, 633A-642A). However, the extraction technique which is most fascinating from the environmental and occupational health and safety points of view is solid-phase microextraction (SPME) developed by Pawliszyn and coworkers (Berladi, R. P.; Pawliszyn, J. Water Pollut. Res. J. Can. 1989, 24, 179-91; Arthur, C. L.; Pawliszyn, J. Anal. Chem. 1990, 62, 2145). SPME completely eliminates the use of organic solvents for the extraction of analytes from a wide range of matrices. Another important feature of SPME is that, unlike conventional extraction techniques, it does not require exhaustive extraction-establishment of equilibria between the sample matrix and the stationary phase coating is sufficient to obtain quantitative extraction data. For most samples, the equilibration time is less than 30 minutes, which places SPME among the fastest extraction techniques.

In SPME, the outer surface of a solid fused silica fiber (approximately 1 cm at one end) is coated with a selective stationary phase. Thermally stable polymeric materials that allow fast solute diffusion are commonly used as stationary phases. The extraction operation is carried out by simply dipping the coated fiber into the sample matrix and allowing time for the partition equilibrium to be established. The sensitivity of the method is mostly governed by the partition coefficient of an analyte between the coating and the matrix. Extraction selectivity can be achieved by using appropriate types of stationary phases that exhibit high affinity toward the target analytes.

In its traditional format, SPME has a number of drawbacks. First, since the stationary phase coating is applied to the outer surface of the fiber, it is more vulnerable to mechanical damage. Second, traditional methods for the preparation of coatings fail to provide adequate thermal and solvent stability to the thick stationary phase (several tens of micrometers in thickness) coatings that are needed in SPME. This is due to the lack of chemical bonding between the coatings and the substrate to which they are applied.

In recent years, the extraction of analytes by GC stationary phase coatings on the capillary inner surface has received considerable attention. The introduction of in-tube SPME had the primary purpose of coupling SPME to high-performance liquid chromatography (HPLC) for automated applications. The in-tube SPME method uses a flow-through process where a coated capillary is employed for the direct extraction of the analytes from the aqueous sample. The extraction process involves agitation by sample flow in and out of the extraction capillary. Successful coupling of in-tube SPME with HPLC, as well as HPLC-MS, has been achieved for the specification of organoarsenic compounds, (Wu, J.; Mester, Z.; Pawliszyn, J. Anal. Chem. 1999, 71, 4237-4244) and determination of rantidine, (Kataoka, H.; Lord, H. L.; Pawliszyn, J. J. Chromatogr. B 1999, 731, 353-359) β-blockers, (Kataoka, H.; Narimatsu, S.; Lord, H.; Pawliszyn, J. Anal. Chem. 1999, 71, 4237-4244) carbamate pesticides, (Gou, Y.; Pawliszyn, J. Anal. Chem. 2000, 72 2774-2779; Gou, Y.; Eisert, R.; Pawliszyn, J. J. Chromatogr. A 2000, 873, 137-147; Gou, Y.; Tragas, C.; Lord, H.; Pawliszyn, J. J. Micro September 2000, 12, 125-134) and aromatic compounds (Wu, J.; Pawliszyn, J. J. Chromatogr. A 2001, 909, 37-52).

In spite of rapid on-going developments, especially in the areas of in-tube SPME applications, a number of fundamental problems remain to be solved. First, GC capillaries that are used for in-tube SPME typically have thin coatings that significantly limit the sample capacity (and hence sensitivity) of the technique. Conventional static coating techniques (Bouche, J.; Verzele, M. J. Gas Chromatogr. 1968, 6, 501-505; Janak, K.; Kahle, V.; Tesarik, K.; Horka, M. J. High Resolut. Chromatogr./Chromatogr. Commun. 1985, 8, 843-847; Sumpter, S R.; Woolley, C. L.; Hunag, E. C.; Markides, K. E.; Lee, M. L. J. Chromatogr. 1990, 517, 503-519) used to prepare stationary phase coatings in GC columns are designed primarily for creating thin (sub-micrometer thickness) coatings. Thus, developing an alternative technique to provide higher coating thickness suitable for in-tube SPME applications is very important.

Second, usually the stationary phase coatings used in GC capillaries are not chemically bonded to the capillary surface. In conventional approaches, these relatively thin coatings are immobilized on the capillary inner surface through free-radical cross-linking reactions. (Wright, B. W.; Peaden, P. A.; Lee, M. L.; Stark, T. J. J. Chromatogr. 1982, 248, 17-34; Blomberg, L. G. J. Microcol. September 1990, 2, 62-68). Immobilization of thicker coatings (especially the polar ones) is difficult to achieve. (Janak, K.; Horka, M.; Krejci, J. J. Microcol. September 1991, 3, 115-120; Berezkin, V. G.; Shiryaeva, V. E.; Popova, T. P. Zh. Analit. Khim. 1992, 47, 825-831). Third, because of the absence of direct chemical bonding between the stationary phase coating and the GC capillary inner walls, the thermal and solvent stabilities of such coatings are typically poor or moderate. When such extraction devices are coupled to GC, reduced thermal stability of thick GC coatings leads to incomplete sample desorption and sample carryover problems. (Buchholz, K. D.; Pawlyszyn, J. Anal. Chem. 1994, 66, 160-167; Zhang, Z.; Yang, M. J.; Pawliszyn, J. Anal. Chem. 1994, 66, 844A-853A.; Potter, D. W.; Pawliszyn, J. Environ. Sd. Technol. 1994, 28, 298-305).

Low solvent stability of conventionally prepared thick stationary phase coatings present a significant obstacle to the hyphenation of in-tube SPME with liquid-phase separation techniques that employ organic or organoaqueous mobile phase systems of the desorption of analytes. Solvent stability of the in-tube SPME coatings is, therefore, fundamentally important for further development of the technique. (Wu, J.; Pawliszyn, J. Anal. Chem. 2001, 73, 55-63). Thus, these three problems need to be solved in order to exploit full analytical potential of in-tube SPME.

### SUMMARY OF THE INVENTION

In accordance with the present invention, there is provided methods of pre-concentrating trace analytes by extracting polar and non-polar analytes through a sol-gel coating and/or sol-gel monolithic bed. The present invention further provides microextraction methods including the steps of micro-extracting polar and non-polar analytes in a sol-gel coating and/or sol-gel monolithic bed, desorbing the analytes from the sol-gel and analyzing the extracted, desorbed analytes. The present invention also concerns microextraction devices useful for preconcentrating trace analytes, wherein the devices contain sol-gel extraction mediums. Another aspect of the present invention pertains a microextraction device in accordance with the present invention in hypenation with a chromatographic column, for example, a gas chromatographic column or a high-pressure liquid chromatographic column.

### DESCRIPTION OF THE DRAWINGS

Other advantages of the present invention are readily appreciated as the same becomes better understood by reference to the following detailed description when considered in connection with the accompanying drawings wherein:

FIGS. 1A and 1B show an extraction tube made in accordance with the present invention.

FIG. 2 shows a schematic perspective representation of a gas chromatograph injector port and a capillary tube made in accordance with the present invention connected with a gas chromatographic column.

FIG. 3 shows a gas chromatographic analysis of PAHs extracted from water in accordance with the present invention.

FIG. 4 is a gas chromatographic analysis of alcohols using the sol-gel capillary microextraction of the present invention.

FIG. 5 is a gas chromatographic analysis showing microextraction of polar and non-polar analytes from water.

FIG. 6 is a gas chromatographic analysis showing separation of ketones using the capillary microextraction technology of the present invention.

FIG. 7 is a gas chromatographic analysis showing the separation of fluorene from hexadecanol after capillary microextractions utilizing a sol-gel monolithic bed in accordance with the present invention.

FIG. 8 is a comparison of gas chromatographic analyses showing the separation of fluorene from hexadecanol after capillary microextractions in accordance with the present invention utilizing a monolithic bed versus an open tubular construction.

FIG. 9 is a schematic side view, partially broken away, of a gravity-fed extraction system for capillary microextraction made in accordance with the present invention.

FIG. 10 is a schematic view of a capillary filling/purging device made in accordance with the present invention.

FIG. 11 is a scanning electron microscopic image of 250 μm i.d. microextraction capillaries with sol-gel PDMS in FIG. 11A and sol-gel PEG, as shown in FIG. 11B coatings, magnification being 10,000×.

FIG. 12 is a capillary microextraction analysis of PAH's at ppb- and sub-ppb level concentrations using a sol-gel PDMS coated capillary made in accordance with the present invention.

FIG. 13 is a capillary microextraction analysis of aldehydes using a sol-gel PDMS coated capillary at 100 ppb analyte concentration.

FIG. 14 is a capillary microextraction analysis of ketones using a sol-gel PDMS coated capillary at 100 ppb analyte concentration.

FIG. 15 is an illustration of extraction kinetics of fluorene and decanophenone (▴) obtained on a 3.5 cm×250 μm i.d. sol-gel PDMS coated microextraction capillary using 1 ppm aqueous solutions.

FIG. 16 is a capillary microextraction-GC analysis of dimethylphenol isomers using a sol-gel PEG coated capillary at 10 ppb analyte concentration.

FIG. 17 is a capillary microextraction analysis of alcohols and amines using a sol-gel PEG coated capillary at 10 ppb analyte concentration.

FIG. 18 is a scanning electron micrograph of a cross section of a monolithic bed made in accordance with the present invention.

FIGS. 19A and 19B are IR spectras representing: pure silanol-terminated PDMDPS copolymer with 2-3% diphenyl-containing component; and sol-gel zirconia-PDMDPS material prepared using PDMDPS copolymer with 14-18% diphenyl-containing component, respectively.

FIGS. 20A and 20B are scanning electron microscopic images of a 0.32 mm i.d. Sol-gel zirconia-PDMDPS coated microextraction capillary. FIG. 20A illustrates a cross-sectional view (1000×) of a roughened surface obtained by the sol-gel coating process. FIG. 20B illustrates the coating thickness (10,000×).

FIG. 21 shows CME-GC analysis of PAHs using a sol-gel zirconia-PDMDPS coated extraction capillary. Extraction parameters: 10 cm×0.32 mm i.d. microextraction capillary; extraction time, 30 min (gravity fed at room temperature). Other conditions: 10 m×0.25 mm i.d. Sol-gel PDMS GC column; splitless desorption; injector temperature rose from 30° C. to 300° C.: column temperature program from 30° C. to 300° C. at rate of 20° C./min; helium carrier gas: FID 350° C. Peaks: (1) naphthalene; (2) acenaphthene; (3) fluorene; (4) phenanthrene; (5) pyrene; and (6) naphthacene.

FIG. 22 shows CME-GC analysis of aldehydes using a sol-gel zirconia-PDMDPS coated extraction capillary. Extraction parameters: 10 cm×0.32 mm i.d. microextraction capillary; extraction time, 40 min (gravity fed at room temperature). Other conditions: 10 m×0.25 mm i.d. Sol-gel GC PDMS column; splitless desorption; injector temperature rose from 30° C. to 300° C.: column temperature program from 30° C. to 300° C. at rate of 20° C./min; helium carrier gas: FID 350° C. Peaks: (1) nonylaldehyde; (2) n-decylaldehyde; (3) undecylic aldehyde; and (4) dodecanal.

FIG. 23 shows CME-GC analysis of ketones using a sol-gel zirconia-PDMDPS coated extraction capillary. Extraction parameters: 10 cm>×0.32 mm i.d. microextraction capillary; extraction time, 40 min (gravity fed at room temperature). Other conditions: 10 m×0.25 mm i.d. Sol-gel PDMS GC column; splitless desorption; injector temperature rose from 30° C. to 300° C.: column temperature program from 30° C. to 300° C. at rate of 20° C./min; helium carrier gas: FID 350° C. Peaks: (1) valerophenone; (2) hexanophenone; (3) heptanophenone; (4) decanophenone; and (5) trans-chalcone.

FIG. 24 shows CME-GC analysis of mixture of PAHs, aldehydes and ketones using a sol-gel zirconia-PDMDPS coated extraction capillary. Extraction parameters: 10 cm×0.32 mm i.d. microextraction capillary; extraction time, 40 min (gravity fed at room temperature). Other conditions: 10 m×0.25 mm i.d. Sol-gel PDMS GC column; splitless desorption; injector temperature rose from 30° C. to 300° C.: column temperature program from 30° C. to 300° C. at rate of 20° C./min; helium carrier gas: FID 350° C. Peaks: (1) naphthalene; (2) n-decylaldehyde; (3) undecylic aldehyde; (4) valerophenone; (5) dodecanal; (6) hexanophenone; (7) fluorene; (8) heptanophenone; (9) phenanthrene; (10) pyrene; and (11) naphthacene.

FIG. 25 shows extraction kinetics of aqueous undecylic aldehyde, heptanophenone, and fluorene on a sol-gel zirconia-PDMDPS microextraction coated capillary. Extraction parameters: 10 cm×0.32 mm i.d. microextraction capillary; Other conditions: 10 m×0.25 mm i.d. Sol-gel GC PDMS column; splitless desorption; injector temperature from 30° C. to 300° C.: column temperature program from 30° C. to 300° C. at rate of 20° C./min; helium carrier gas: FID 350° C.

FIGS. 26A and 26B show CME-GC analysis of PAHs using a sol-gel zirconia-PDMDPS coated microextraction capillary. FIG. 26A represents the analysis before rinsing the microextraction capillary with 0.1M NaOH solution for 24 h. FIG. 26B represents the analysis after rinsing the microextraction capillary with a 0.1M NaOH solution for 24 hours. Extraction parameters: 10 cm×0.25 mm i.d. microextraction capillary; coating thickness 0.3 mm, extraction time, 30 min (gravity fed at room temperature). Other conditions: 10 m×0.25 mm i.d. Sol-gel GC PDMS column; splitless desorption; injector temperature rose from 30° C. to 300° C.: column temperature program from 30° C. to 280° C. at rate of 20° C./min then from 280° C. to 300° C. at rate of 2° C./min; helium carrier gas: FID 350° C. Peaks: (1) acenaphthene; (2) fluorene; (3) phenanthrene; and (4) pyrene.

FIGS. 27A and 27B show CME-GC analysis of PAHs using a commercially coated capillary with 0.25 mm coating thickness: before (A) and after (B) rinsing the microextraction capillary with 0.1M NaOH solution for 24 h. Extraction parameters: 10 cm×0.25 mm i.d. microextraction capillary; extraction time, 30 min (gravity fed at room temperature). Other conditions: 10 m×0.25 mm i.d. Sol-gel GC PDMS column; splitless desorption; injector temperature rose from 30 to 300° C.: column temperature program from 30 to 280° C. at rate of 20° C./min then from 280 to 300° C. at rate of 2° C./min; helium carrier gas: FID 350° C. Peaks: (1) acenaphthene; (2) fluorene; (3) phenanthrene; and (4) pyrene.

### DETAILED DESCRIPTION OF THE INVENTION

Generally, the present invention provides methods and apparatus for pre-concentrating trace analytes. Most generally, the methods involve the step of extracting polar and non-polar analytes through a sol-gel coating or monolithic bed. In a specific embodiment, the sol-gel has the formula: 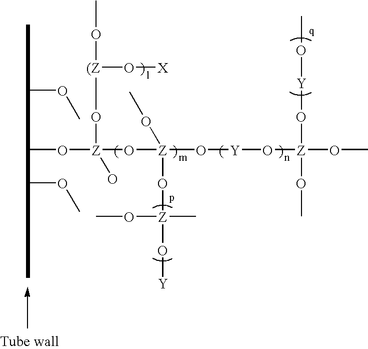
wherein,
X=Residual of a deactivation reagent (e.g., polymethylhydrosiloxane (PMHS), hexamethyldisilazane (HMDS), etc.);
Y=Sol-gel reaction residual of a sol-gel active organic molecule (e.g., hydroxy terminated molecules including polydimethylsiloxane (PDMS), polymethylphenylsiloxane (PMPS), polydimethyldiphenylsiloxane (PDMDPS), poly(methyl-cyanopropylsiloxane) octadecylsilane, octylsilane, dendrimers, polystyrene, polystyrenedivinylbenzene, polyacrylate, molecularly imprinted polymers, polyethylene glycol (PEG) and related polymers like Carbowax 20M, polyalkylene glycol such as Ucon, macrocyclic molecules like cyclodextrins, crown ethers, calixarenes, alkyl moieties like octadecyl, octyl, etc.)
Z=Sol-gel precursor-forming chemical element (e.g., Si, Al, Ti, Zr, etc.)
l=An integer ≧0;
m=An integer ≧0;
n=An integer ÷0
p=An integer ≧0;
q=An integer ≧0;
and l, m, n, p, and q are not simultaneously zero.
Dotted lines indicate the continuation of the chemical structure with X, Y, Z, or Hydrogen (H) in space.

In order to achieve the desired sol-gels of the instant invention, certain reagents in a reagent system were preferred for the fabrication of the gels for the monolithic columns of the present invention. The reagent system included two sol-gel precursors, a deactivation reagent, one or more solvents and a catalyst. For the purposes of this embodiment, one of the sol-gel precursors contains a chromatographically active moiety selected from the group consisting of octadecyl, octyl, cyanopropyl, diol, biphenyl, phenyl, cyclodextrins, crown ethers and other moieties. Representative precursors include, but are not limited to: tetramethoxysilane, 3-(N-styrylmethyl-2-aminoethylamino)-propyltrimethoxysilane hydrochloride, N-tetradecyldimethyl(3-trimethoxysilylpropyl)ammonium chloride, N(3-trimethoxysilylpropyl)-N-methyl-N,N-diallylammonium chloride, N-trimethoxysilylpropyltri-N-butylammonium bromide, N-trimethoxysilylpropyl-N,N,N-trimethylammonium chloride, trimethoxysilyipropylthiouronium chloride, 3-[2-N-benzyaminoethylaminopropyl]trimethoxysilane hydrochloride, 1,4-bis(hydroxydimethylsilyl)benzene, bis(2-hydroxyethyl)-3-aminopropyltriethoxysilane, 1,4-bis(trimethoxysilylethyl)benzene, 2-cyanoethyltrimethoxysilane, 2-cyanoethyltriethoxysilane, (cyanomethylphenethyl)trimethoxysilane, (cyanomethylphenethyl)triethoxysifane, 3-cyanopropyldimethylmethoxysilane, 3-cyanopropyltriethoxysilane, 3-cyanopropyltrimethoxysilane, n-octadecyltrimethoxysilane, n-octadecyldimethylmethoxysilane, methyl-n-octadecyldiethoxysilane, methyl-n-octadecyldimethoxysilane, n-octadecyltriethoxysilane, n-dodecyltriethoxysilane, n-dodecyltrimethoxysilane, n-octyltriethyoxysilane, n-octyltrimethoxysilane, n-ocyldiisobutylmethoxysilane, octylmethyldimethoxysilane, n-hexyltriethoxysilane, n-isobutyltriethoxysilane, n-propyltrimethoxysilane, phenethyltrimethoxysilane, n-phenylaminopropyltrimethoxysilane, styrylethyltrimethoxysilane, 3-(2,2,6,6-tetramethylpiperidine-4-oxy)-propyltriethoxysilane, n-(3-triethoxysilylpropyl)acetyl-glycinamide, (3,3,3-trifluoropropyl)trimethoxysilane, and (3,3,3-trifluoropropyl)methyldimethoxysilane.

In one specific embodiment, a second sol-gel precursor, N-octadecyldimethyl[3-(trimethoxysilyl)propyl]ammonium chloride, was found to be desirable since it possessed an octadecyl moiety that allowed for chromatographic interactions of analytes with the monolithic stationary phase. Additionally, this reagent served to yield a positively charged surface, thereby providing the relatively high reversed electroosmotic flow necessary in capillary electrochromatography. However, it is considered within the scope to use any other reagent as known to one of ordinary skill in the art that would contain the octadecyl moiety for the purposes already set forth.

The deactivation reagent comprises a material reactive to polar functional groups bonded to the sol-gel precursor forming element in the coating or tube structure. Preferably, the deactivation reagent is reactive to hydroxyl functional groups. In one specific embodiment, the deactivation reagent is phenyldimethylsilane, polymethylhydrosiloxane, 1,1,1,3,3,3-hexamethyldisilazane, or a combination of any of the foregoing.

The sol-gel catalyst is generally either an acid, a base, or a fluoride compound. Preferably, the catalyst is trifluoroacetic acid (TFA). Advantageously, TFA can also function as a source of water. Preferably, the TFA contains about 5% water (i.e., TFA/water 95:5 v/v).

More specifically, the present invention provides the method of pre-concentrating both polar and non-polar analytes by feeding a sample through a sol-gel coated inner-surface of a tube or through a sol-gel monolithic bed and extracting analytes from the sample utilizing the sol-gel coating.

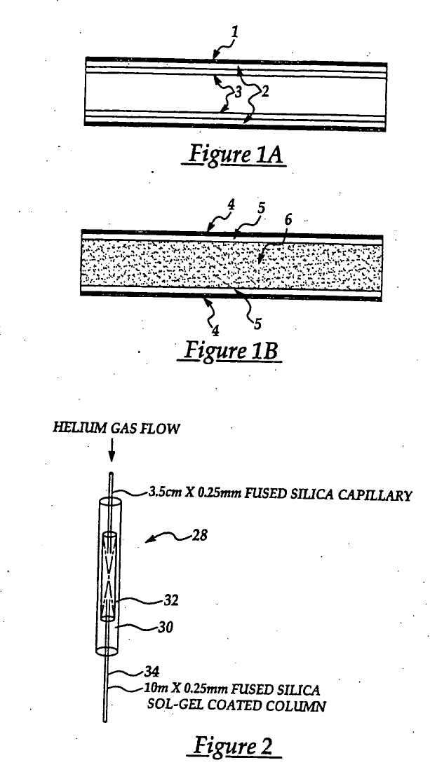

FIGS. 1A and 1B show extraction tubes made in accordance with the present invention. FIG. 1A (FIG. 1B discussed below) shows a tube wall 2, preferably made from fused silica but can be made from other materials known in the art, having an inner sol-gel containing 3. A protective outer coating 1 is dispersed over the outer surface of the tube 2, and defines the outer surface of the extraction tube device. The protective polymeric outer coating is most commonly made out of polyimide. The protective coating comes as a standard feature of the commercially available fused silica capillary. The protective coating is applied to the outer surface during capillary manufacturing process. It is not part of the present invention.

FIG. 1B shows an alternative extraction tube device. A tube wall 5 contains a sol-gel monolithic bed 6 there within. The tube wall 5 includes a protective coating 4 disposed over its outer surface.

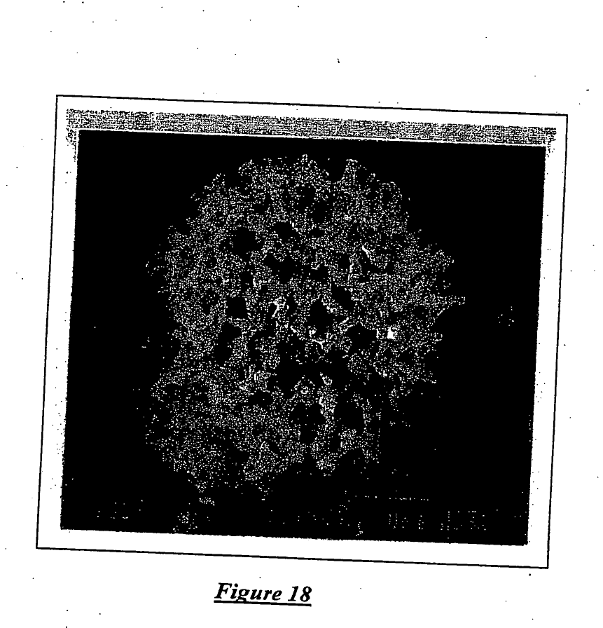

FIG. 18 is a scanning electron micrograph cross section of a fused silica capillary tube containing the monolithic sol-gel bed there within. The matrix structure of the bed is shown.

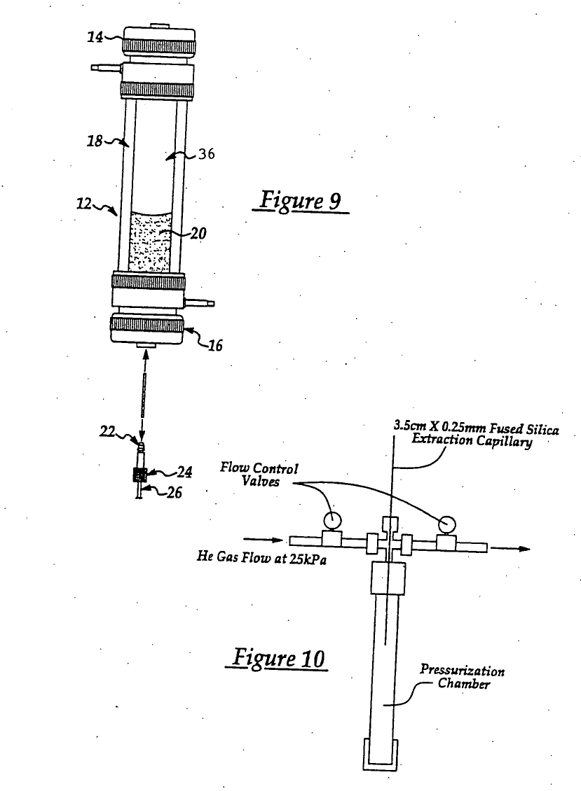

FIG. 9 is an example of capillary microextraction apparatus made in accordance with the present invention. FIG. 9 shows a glass sample reservoir, generally indicated at 10, for use in capillary microextraction in accordance with the present invention. The apparatus consists of a column generally shown at 12 and top and bottom screw caps 14 and 16. The column 12 includes an internal deactivated glass column 36 surrounded by an acrylic jacket 18. As shown in the cross-section in FIG. 9, the gravity feed microextraction system is shown to include the acrylic jacket 18 surrounding the sample containing the analytes of interest 20 disposed within the deactivated glass column 36. The lower screw cap 16 is connected through a polypropylene ferrule 22 and a connecting plastic nut 24 to PEEK tubing 26.

FIG. 2 illustrates introduction of an extracted sample into a gas chromatograph. The device shown generally at 28 includes a glass insert 30 surrounding a fused silica two-way capillary connector 32. Retained by the connector is a fused silica sol-gel coated column 34 made by the process described below.

The preparation of the sol-gel coating on the inner surface of a tube includes the steps of providing the tube structure, a sol-gel solution comprising a sol-gel precursor, an organic material with at least one sol-gel active functional group, a sol-gel catalyst, a deactivation agent, and a solvent system as defined above. In one embodiment, the tube is hydrothermally pretreated. The sol-gel solution is then reacted with the inner surface of the tube under controlled conditions to produce a surface bonded sol-gel coating on that portion of the tube. The solution is then removed from the tube under pressure of an inert gas and is heated under controlled conditions to cause the deactivation reagent to react with the surface bonded sol-gel coating to deactivate and to condition the sol-gel coated portion of the tube structure. Preferably, the sol-gel precursor includes an alkoxy compound. The organic material includes a monomeric or polymeric material having at least one sol-gel active functional group. The sol-gel catalyst is taken from the group consisting of an acid, a base, and a fluoride compound. The deactivation reagent includes a material reactive to polar functional groups, such as hydroxyl groups, bonded to the sol-gel precursor-forming element in the coating or the tube structure.

The monolithic bed is made by first filling a tube with the sol-gel solution. By this single step filling, a sol-gel is produced that forms a porous matrix to be used for separation purposes. The matrix includes a positively charged surface within the matrix. That is, the microstructure of the sol-gel monolithic separation bed constitutes an infinite number of pathways through the porous matrix. The charges on the surface of the matrix generate an electroosmotic flow. Since the surface is positively charged, a reverse flow is created that is much easier to control than that of the prior art native silica surfaces. Such a monolithic bed provides a particle free sol-gel solution, which forms the preparation bed.

The sol-gel coating and monolithic bed can occur through numerous methodologies, alternative to the above. In a further coating method, the surface is coated with a sol-gel solution than includes a sol-gel precursor that includes, but is not limited to, alkoxysaline precursors such as methyltrimethoxysilane, trialkoxysilanes, and any other similar precursors known to those skilled in the art. Additionally, the sol solution contains a coating polymer that includes, but is not limited to hydroxy terminated polydimethylsiloxane. Finally, common to the preparation as discussed above, the solution contains a deactivation reagent and a sol-gel catalyst. The deactivation reagent can be, but is not limited to, PMHS and any other similar substance known to those skilled in the art. As for the sol-gel catalyst, an acid catalyst such as trifluoroacetic acid containing 5% water (TFA/H₂O 95:5 v/v) is preferred. Once the sol-gel solution is placed onto the surface of the material, conditioning occurs under various parameters known to those skilled in the art. Furthermore, there are two major sets of reactions that take place during sol-gel processing the hydrolysis of the precursor and the polycondensation of the hydrolyzed products and other sol-gel active moieties in the system.

The present invention also encompasses capillary microextraction devices comprising transition metal oxide based hybrid organic-inorganic sorbent, sol-gel coatings. Advantageously, transition-based metal oxides exhibit stability across a wide range of pHs (Nawrocki, J. et al., J. Chromatogr. A 657 (1993) 229; Nawrocki, J. et al., J. Chromatogr. A 1028 (2004) 1; Nawrocki, J. et al., J. Chromatogr. A 1028 (2004) 31) and thus, can be utilized at both low pHs and high pHs where a silica based microextraction device would typically either become hydrolytically unstable (at extremely acidic conditions) or dissolve (at alkaline conditions beginning at a pH of about 8).

Suitable transition metal oxides include, without limitation, zirconia, alumina, and titania. Preferably, the transition metal oxide is zirconia, in part, because it exhibits superior alkali resistance over alumina and titania. Advantageously, zirconia is insoluble within a wide range of pH values (from about 1 to about 14), it exhibits resistance to dissolution at high temperatures and chemical inertness, and it possesses high mechanical strength (Kawahara, M. et al., J. Chromatogr. 515 (1990) 149; Trammell, B. C. et al., Anal. Chem. 73 (2001) 3323; Sun, L. et al. J. Colloid Interface Sci. 163 (1994) 464; Unger et al. High Performance Liquid Chromatography, Wiley, New York, 1989, p. 145; Bien-Vogelsang, U. et al., Chromatographia 19 (1984) 170; Yu, J. et al. J. Chromatogr. 631 (1993) 91).

An exemplary transition metal based sorbent, sol-gel coating is provided below. 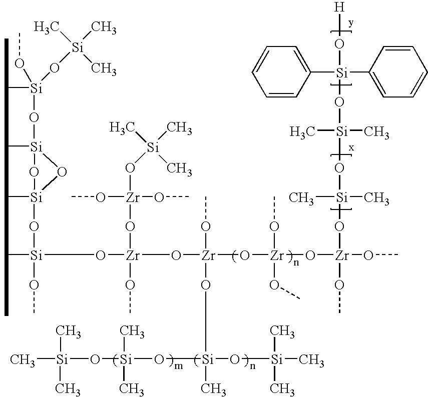
wherein m=An integer ≧0;
n=An integer ≧0
x=An integer ≧0;
y=An integer ≧0;
and m, n, x, and y are not simultaneously zero. Dotted lines indicate the continuation of the chemical structure with Zr, Si, or Hydrogen (H) in space. The inner surface of the capillary is represented on the for left as thick bars.

Another aspect of the present invention concerns methods for preparing transition metal based sorbent, sol-gel microextraction devices. The methods comprise providing a hollow capillary and filling the capillary with a sol solution that can chemically bind to the inner surface of the capillary to form a sorbent extraction medium. In a specific embodiment, the capillary is a fused silica capillary. In yet another specific embodiment, the capillary is a hydrothermally treated capillary. In yet another specific embodiment, the capillary is a fused silica, hydrothermally pretreated capillary.

The sol solution includes a transition metal-based sol-gel precursor, a sol-gel active organic component, a chelating reagent, and a deactivating reagent in a solvent. The transition metal-based sol-gel precursor is selected from reactive transition-metal alkoxides. In one embodiment, the sol-gel precursor is selected from transition-metal alkoxides excluding silica alkoxides. Exemplary alkoxides are those with a zirconium component including, for example and without limitation, zirconium isopropoxide and zirconium tetrapropoxide. Preferably, the sol-gel precursor is zirconium(IV) butoxide.

In one embodiment, the sol-gel active organic component is selected from polydimethylsiloxane (PDMS), polymethylphenylsiloxane (PMPS), silanol-terminated polydimethyldiphenylsiloxane (PDMDPS), or poly(methylcyanopropylsiloxane). Preferably, the sol-gel active component is PDMDPS.

In yet another embodiment, the sol-gel active organic component is selected from octadecylsilane, octylsilane, dendrimers, polystyrene, polystyrenedivinylbenzene, polyacrylate, molecularly imprinted polymers, polyethylene glycol (PEG) and related polymers like Carbowax 20M, polyalkylene glycol such as Ucon, macrocyclic molecules like cyclodextrins, crown ethers, and calixarenes, and alkyl moieties, for example, octadecyl, and octyl.

The chelating reagent is utilized to slow the hydrolysis rate of the sol-gel active precursor and to prevent the transition metal from precipitating out of solution. Any ligand exchange reactant will work with the methods of the present invention, but exemplary chelating agents include, without limitation, glacial acetic acid, valeric acid, β-diketone, triethanolamine, and 1,5-diaminopentane.

The deactivation reagent is selected to derivatize any surface hydroxyl groups that are bound to metals. These sites are strongly adsorptive for polar solutes and their presence results in sample loss, sample carryover, and peak distortion and tailing. The deactivation reagent is a reactive silicon hydride. Preferably, the deactivating reagent is an alkyl hydrosilane or hexamethyldisilazane. In a specific embodiment, the sol solution comprises two deactivation reagents. Prefereably, the two deactivation reagents are poly(methylhydrosiloxane) and 1,1,1,3,3,3-hexamethyldisilazane.

The solvent utilized in the methods for preparing the transition metal-based sol-gel extraction mediums include proponol, 1-butanol, methylene chloride, and a combination of any of the foregoing.

Another aspect of the present invention pertains to an apparatus useful for preconcentrating and identifying target analytes in a sample. The apparatus comprises a microextraction device of the present invention in hyphenation with a chromatographic column.

As detailed in the experimental section below, specific formulations and methods are provided herein.

Any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

### EXPERIMENTAL SECTION

Three series of experiments were conducted demonstrating the applicability and utility of the present invention. Each section discussed below demonstrates both the open tube and monolithic bed columns ability to separate polar and non-polar analytes, even during the same extraction. Likewise, each set of experiments demonstrates the ability of the present invention to separate trace analytes at what was prior thought to be inconceivable trace amounts. Parts per quadrillion extractions were obtained utilizing the monolithic bed of the present invention.

Experimentation Series 1

Chemicals and materials. Fused silica capillary of 250 μm internal diameter (i.d.) was purchased from Polymicro Technologies (Phoenix, Ariz.). HPLC-grade methylene chloride and methanol were purchased from Fisher Scientific (Pittsburgh, Pa.). Trifluoroacetic acid (TFA) and polylrethylhydrosiloxane (PMHS) were procured from Aldrich Chemical Co. (Milwaukee, Wis.). Methyltrimethoxysilane (MTMS) was obtained from United Chemical Co. (Bristol, Pa.). Highly pure deionized water (18 Ω) was prepared in-house from a Barnstead model 04741 Nanopure deionized water system (Barnstead-Thermodyne, Debuque, Iowa). Eppendorf micro centrifuge tubes (1.5 mL) were purchased from Brinkman Instruments (Westbury, N.Y.).

Equipment. Gas chromatographic experiments were carried out on a Shimadzu 17 GC system (Shimadzu Scientific, Baltimore, Md.) equipped with a split/splitless injector 4 and a flame ionization detector (FID). A Barnstead model 04741 Nanopure deionized water system (Bamstead/Thermodyne, Debuque, Iowa) was used to prepare highly pure deionized water (18 Ω). A Microcentaur model APO 5760 centrifuge (Accurage Chemical and Scientific Corp., Westbury, N.Y.) was employed for necessary centrifugation of the sol-gel solution. A Fisher model G-560 Vortex Genie 2 system (Fisher Scientific, Pittsburgh, Pa.) was used for thorough mixing of the sol solution ingredients while preparing the sol solutions. A home-made gas-pressure operated filling/purging device (J. D. Hayes, A. Malik, Anal. Chem. 2000, 72, 4090-4099) was used for filing the fused silica capillary with the sol solution, as well as rinsing and purging with helium at various stages of column preparation.

Preparation of the sol-gel solution. For this, 0.1 g of the selected sol-gel-active polymer was dissolved in 100 μL of methylene chloride placed in a micro centrifuge tube (1.5 mL). PMHS (40 μL) and MTMS (100 μL) were added to this solution, and the contents of the centrifuge tube were thoroughly vortexed. Finally, 100 μL of TFA containing 5% water (sol-gel catalyst and source of water) was added and centrifuged for 4 mm at 13,000 rpm (15,682 G) to separate out any precipitate that might have formed during the mixing process. The clear sol solution from the top part of the centrifuge tube was then transferred to a clean vial for further use.

Preparation of Coatings for Capillary Microextraction. The sol-gel solution was used to prepare open tubular GC columns following a general procedure described in an earlier publication (D. X. Wang, S. L. Chong, and A. Malik, Anal. Chem., 1997, 69 (22), 4566-4576). Briefly, a hydrothermally treated fused silica capillary (10-m×250 μm i.d.) was filled with the sol-gel solution using a home-made filling/purging device (Hayes, J. D.; Malik, A. J. Chromatogr. B., 1997, 695, 3-13) under 100 psi helium pressure. The solution was allowed to stay inside the capillary for 15 min after which it was expelled from the capillary under the same helium pressure. Following this, the capillary was dried by purging it with helium for 30 min at room temperature. The capillary was then thermally conditioned under a continuous flow of helium: from 40° C. to 280° C. @ 1° C. min⁻¹, holding the column at the final temperature for five hours. Finally, the column was rinsed with methylene chloride and dried under helium purge. At this point, the column was ready for analytical use.

Preparation of Monolithic beds for Microextraction. The monolithic extraction beds were prepared according to J. D. Hayes, A. Malik, Anal. Chem. 2000, 72, 4090-4099. Briefly, a fused silica capillary was filled with the sol solution and allowed to stay inside the capillary for an extended period (a few hours). During this time sol-gel reactions proceed inside the capillary and the sol solution transforms into a porous solid matrix. The capillary is then heated (from 30° C. to the final temperature, which may vary depending on the monolith material using a program rate of @ 0.2° C. min⁻¹) with both ends sealed, holding it at the final temperature for two hours. After this, the monolithic capillary is rinsed with a series of appropriate solvents (e.g., methylene chloride, methanol and water). Finally, the monolith is thermally conditioned (e.g., at 300° C.) with continuous purge with an inert gas before use for extraction.

Result and Discussion

FIG. 9 shows the glass sample reservoir used for capillary microextraction. It was properly deactivated using a surface derivatizing reagent (e.g., hexamethyldisilazane, HMDS) before use. It is vertically clamped with the water sample inside it. The surface-coated capillary/monolithic capillary was connected to the lower end, and the sample was allowed to flow through it for 30 minutes. After that, the capillary was purged with helium at room temperature for up to 5 minutes. It was placed inside the GC injector port and connected with a GC column (also made by sol-gel technology) with the help of a press-fit fused silica connector (FIG. 2). The extracted sample was desorbed by using a fast temperature programming of the GC injector.

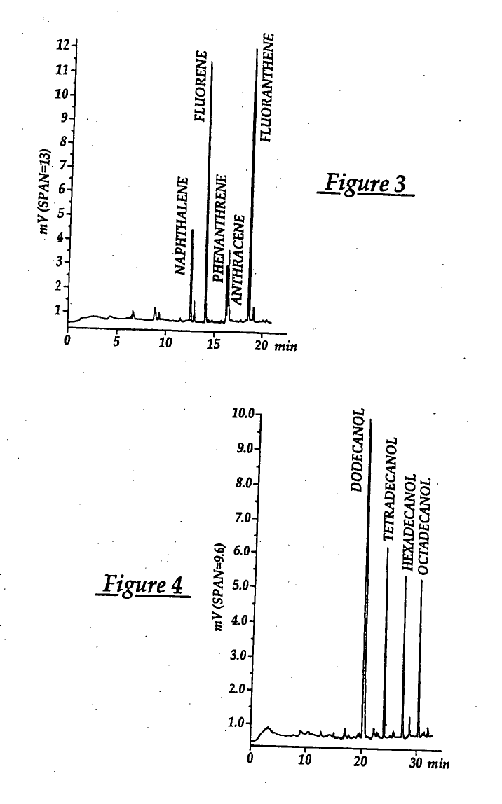

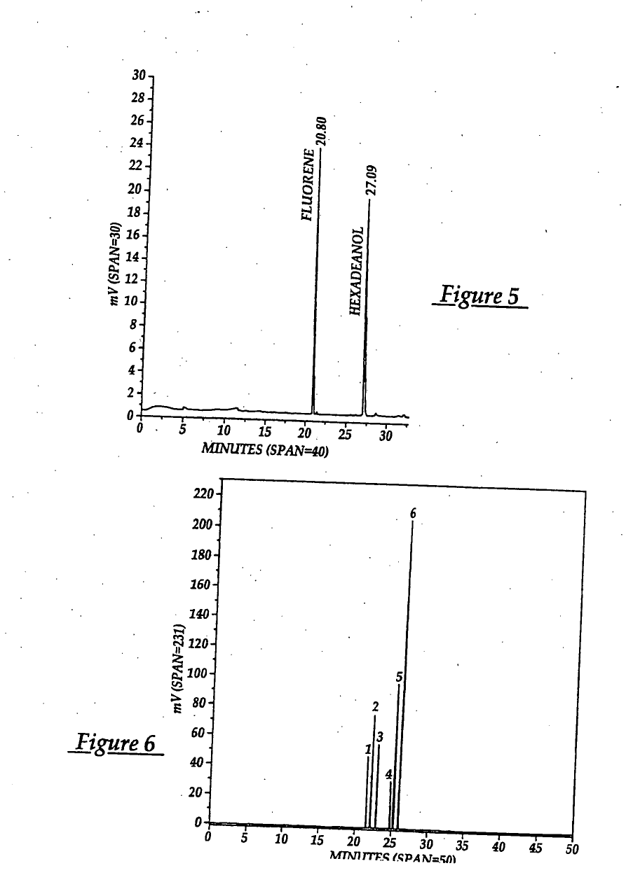

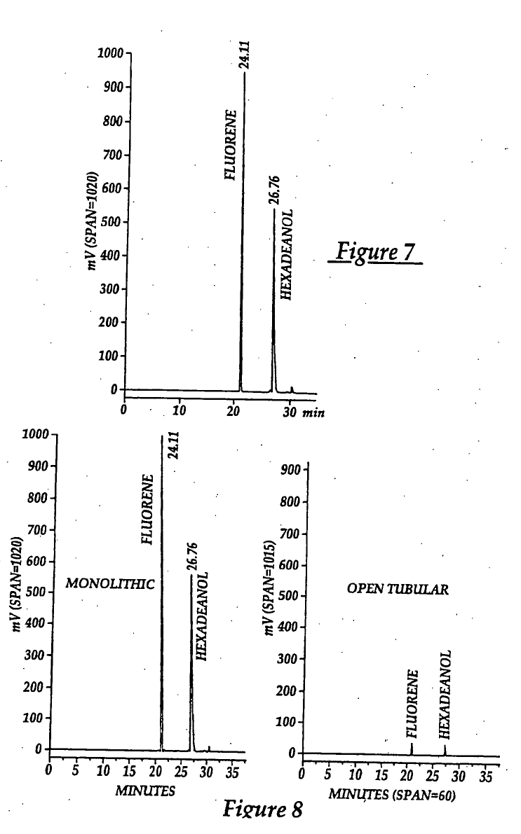

FIGS. 3-6 illustrate the performance of microextraction capillaries with surface-bonded sol-gel coatings. As can be seen from these figures, sol-gel coated microextraction capillaries can extract both polar and non-polar analytes from aqueous environments. Moreover, these coatings can extract both types of analytes simultaneously. The same is true for sol-gel microextraction capillaries with monolithic beds as illustrated in FIGS. 7-8. As is evident from FIG. 8, sol-gel monolithic microextraction capillaries are characterized by sample capacities that are a few orders of magnitude higher than the open tubular counterparts which, in turn, have significantly higher sample capacity than conventional SPME.

Experimentation Series 2

Equipment. SPME-GC experiments were carried out on a Varian Model 3800 capillary GC system equipped with an FID and a Varian Model 1079 temperature programmable split-splitless injector. Simple modifications to the split/splitless injector were made such that an extraction capillary could be inserted completely inside the injection port. An in-house designed liquid sample reservoir (FIG. 9) was used to facilitate gravity-fed flow of the aqueous samples through the sol-gel microextraction capillary. A Microcentaur model APO 5760 microcentrifuge (Accurage Chemical and Scientific Corp., Westbury, N.Y.) was used for centrifugation (@13,000 RPM; 15,682 g) of sol solutions used in the preparation of sol-gel coated capillaries. A Fisher model G560 Vortex Genie 2 system (Fisher Scientific, Pittsburgh, Pa.) was used for thorough mixing of various solutions. A homemade, gas pressure-operated capillary filling/purging device was used to purge the sol-gel extraction capillary with helium after performing the microextraction procedure. A Barnstead Model 04741 Nanopure deionized water system (Barnstead/Thermolyne, Dubuque, Iowa) was used to obtain 17.6 MΩ water. On-line data collection and processing were done using ChromPerfect for Windows (Version 3.5) computer software (Justice Laboratory Software, Mountain Views, Calif.).

Chemicals and materials. Fused silica capillary (250-Ωm i.d.) with protective polyimide coating was purchased from Polymicro Technologies Inc. (Phoenix, Ariz.). Naphthalene and HPLC-grade solvents (tetrahydrofuran (THE), methylene chloride, and methanol) were purchased from Fisher Scientific (Pittsburgh, Pa.). The ketone, 4′-phenylacetophenone, was obtained from Eastman Organic Chemicals (Rochester, N.Y.). Hexamethyldisilazane (HMDS), poly(methylhydrosiloxane) (PMHS), trifluoroacetic acid (TFA), ketones (valerophenone, hexanophenone, heptonophenone, decanophenone, anthraquinone), aldehydes (benzaldehyde, nonylaldehyde, tolualdehyde, n-decylaldehyde, undecylic aldehyde), PAHs (acenaphthylene, flourene, phenanthrene, fluoranthene), and phenols (2,6-dimethylphenol, 2,5-dimethylphenol, 2,3-dimethylphenol, 3,4-dimethylphenol) were purchased from Aldrich (Milwaukee, Wis.). Hydroxy-terminated poly(dimethylsiloxane) (PDMS) and methylthrimethoxysilane (MTMS) were purchased from United Chemical Technologies, Inc. (Bristol, Pa.). Trimethoxysilane-derivatized polyethylene glycols (M-SIL-5000 and SIL-3400) were obtained from Shearwater Polymers (Huntsville, Ala.).

Preparation of Aqueous Standard Solutions for Capillary Microextraction. Stock solutions of polycyclic aromatic hydrocarbons (PAHs) (naphthalene, acenaphthylene containing 20% acenaphthene, fluorene, phenanthrene, fluoranthene) and ketones (4′-phenylacetophenone and anthraquinone) were prepared by dissolving 10 mg of each compound in 10 mL of THF in a 10 mL volumetric flask at room temperature. A 25-μL portion of this standard solution was diluted with deionized water to give a total volume of 25 mL that corresponded to a 1 ppm PAH aqueous solution. Preparation of 100 ppb and 1 ppb PAH solutions were accomplished by further dilution of this stock solution with deionized water. Stock solutions of ketones (valerophenone, hexanophenone, heptonophenone, decanophenone) or aldehydes (benzaldehyde, nonylaldehyde, tolualdehyde, n-decylaldehyde, undecyclic aldehyde) were also prepared using THF as the initial organic solvent. Stock solutions of dimethylphenol (DMP) isomers (2,6-dimethylphenol, 2,5-dimethylphenol, 2,3-dimethylphenol, 3,4-dimethylphenol) were prepared in an analogous way-using methanol as the initial organic solvent. Prior to extraction, all glassware was deactivated. The glassware was cleaned using Sparkleen detergent and rinsed with generous amounts of deionized water, and dried at 150° C. for two hours. The inner surface of the dried glassware was then treated with 5% v/v solution of HMDS in methylene chloride, followed by placing of the glassware in an oven at 250° C. overnight. The glassware were then rinsed sequentially with methylene chloride and methanol, and further dried in the oven at 100° C. for 1 hour. Before use, they were rinsed with generous amounts of deionized water and dried at room temperature in a flow of helium.

Preparation of Sol-gel Coated Capillaries. Sol-gel PDMS and PEG extraction capillaries, as well as the sol-gel open-tubular GC columns, were prepared according to procedures described elsewhere and as follows. (Wang, D. X., Chong, S. L., Malik, A. Anal. Chem. 1997, 69, 4566-4576). Briefly a previously cleaned and hydrothermally treated fused silica capillary was filled with a specially designed sol solution using a helium pressure operated filling/purging device (FIG. 10). The sol solution was prepared by dissolving appropriate amounts of a sol-gel precursor (e.g., methyltrimethoxysilane), a sol-gel-active organic polymer (e.g., hydroxyterminated polydimethylsiloxane), a surface deactivation reagent (e.g., polymethylhydrosiloxane), and a sol-gel catalyst (e.g., trifluoroacetic acid) in a suitable solvent system. After filling, the sol solution was allowed to stay inside the capillary for 20-30 minutes. During this residence time, an organic-inorganic hybrid sol-gel network evolves in the sol solution within the confined environment of the fused silica capillary, and a thin layer of this sol-gel stationary phase evolving in close vicinity of the capillary walls gets chemically bonded to it as a result of condensation reaction with the silanol groups on the capillary inner surface. After this residence period, the residual sol solution was expelled form the capillary under helium pressure using the filling/purging device.

The sol-gel coated capillary was further purged with helium for one hour, and conditioned in a GC using temperature programming (from 40° C. @ 1° C./min). The capillary was held at the final temperature (350° C. for sol-gel PDMS and 300° C. for sol-gel PEG) for five hours. During conditioning, the capillary was constantly purged with helium at a linear velocity of 20 cm/s. Before using for extraction, the capillary was sequentially rinsed with methylene chloride and methanol followed by drying the capillary in a stream of helium under temperature programming (from 40° C. to 250° C., @ 4° C./min, 60 min at 250° C.).

Gravity-Fed Sample Reservoir for Capillary Microextraction. The gravity-fed sample reservoir for capillary microextraction (FIG. 9) was made by in-house modification of a Chromaflex AQ column (Kontes Glass Co., NJ) consisting of a thick-walled glass cylinder coaxially placed inside an acrylic jacket. For this, the bottom screw caps, jacket sealing rings, vinyl o-rings, nylon bed support, and acrylic jacket were removed from the Chromaflex AQ column. The thick walled glass column was unscrewed, and its inner surface was deactivated using a 5% v/v solution of HMDS in methylene chloride. First, the inner walls of the glass were rinsed with the HMDS solution. This was followed by temperature-programmed heating of the column from 40° C. to 300° C. at 1° C./min with a hold-time of 3 hours at the final temperature. The deactivated glass column was then sequentially rinsed with 10 mL each of methylene chloride and methanol to remove any excess residue. The heavy walled glass column was further heated at 250° C. for 1 hour. The column was then cooled down to ambient temperature, thoroughly rinsed with liberal amounts of deionized water, and dried in a helium flow. The entire Chromaflex AQ column was subsequently reassembled. The PEEK tubing nut was removed from the bottom screw cap of the Chromaflex AQ column. A piece of 2″×0.02″ i.d.×0.062″ o.d. PEEK tubing was cut, and a polypropylene ferrule was placed on one end of the tubing. The tubing was placed through a connecting plastic nut. The extraction capillary was placed into the tubing leaving a 1 cm portion extending out from the bottom and a 0.5 cm portion from the top. The connecting plastic nut was screwed tightly into the bottom screw cap of the Chromaflex AQ column to ensure a leak-free connection.

Thermal Desorption of Extracted Analytes in the GC Injection Port. To facilitate thermal desorption of the extracted analytes from sol-gel microextraction capillary for their subsequent introduction into the GC capillary column, the Varian Model 1079 split/splitless injector was slightly modified. For this, the quartz wool was removed from the glass insert to accommodate a two-way fused silica connector within the insert. With the glass insert (now without the quartz wool) in place, the injection port was cooled down to ambient temperature. The metallic nut at the top of the injector together with the rubber septum, the septum support, and the glass insert were temporarily removed from the injection port. The injector end of the GC capillary column was then pushed for the bottom of the injector to pass it through the injection port and the glass insert (now located outside the port) such that about 10-15 cm of the capillary column extends out from the top of the insert. This end of the column was press-fitted into the lower end of the deactivated two-way fused silica connector. The two-way connector with press-fitted column end was then secured inside the glass insert, which was subsequently placed back into injection port so that the two-way butt connector with the attached GC column head remained within the glass insert. The septum support was replaced on top of the glass insert. The septum was replaced, and the injector nut was tightened down. Finally, the capillary column was secured inside the oven by tightening the ferrule connection at the bottom of the injection port. After performing capillary microextraction, the extraction capillary was connected to the system in the following way. The capillary column nut at the bottom of the injector was loosened and the column was slid up. The extraction capillary was passed through the septum support and pressed-fitted into the fused silica two-way butt connector. The column was then pulled down until the extraction capillary disappeared below the septum support and remained inside the glass insert (FIG. 10). The septum was replaced, and the injector nut and the capillary column nut were tightened down.

Sol-gel Capillary Microextraction-GC Analysis. Sol-gel PDMS and sol-gel PEG-coated capillaries were used for extraction. Prior to extraction, the sol-gel coated extraction capillary was first thermally conditioned with a simultaneous flow of helium through it. This involved using helium carrier gas at 10 psi and setting the initial GC temperature at 40° C. with the extraction capillary connected to the injection port. The GC temperature was increased at a rate of 5° C./min until 250° C. was reached. The rate of GC temperature increase was then changed to 1° C./min. For sol-gel PDMS- and sol-gel PEG-coated capillaries the final conditioning temperatures were 350° C. and 300° C., respectively. The extraction capillaries were held at the final temperatures for 60 minutes with continuous helium flowing through them.

After conditioning, the extraction capillary was cooled to room temperature, removed from the GC, and installed on the homemade sample reservoir (FIG. 9).

To perform capillary microextraction the extraction capillary was vertically connected to the empty reservoir by removing the PEEK tubing nut from the bottom screw cap, inserting the capillary into the peek tubing (so that ˜1 cm of capillary remained extended from the bottom and ˜0.5 cm from the top of the tubing), and reassembling the apparatus. The aqueous sample (25 mL) was placed in the reservoir, and allowed to flow through the extraction capillary under gravity for 30 minutes for equilibrium to be established. After this, the microextraction capillary was removed from the gravity-fed apparatus and immediately connected to the homemade capillary filling/purging device (FIG. 2). The extraction capillary was purged with helium gas at 25 kPa for 1 minute to remove any excess sample solution. The outer surface of the extraction capillary was wiped clean just before connecting it to the top end of a two-way press-fit fused silica connector placed in temperature programmable split/splitless injector port of the GC, the column inlet being connected to the bottom end of the two-way fused silica connector.

The extracted analytes were then thermally desorbed from the capillary by rapid temperature programming of the injector (@ 100° C./min starting from 30° C.). The nature of the coating used in the capillary determined the final temperature of the ramp (330° C. for sol-gel PDMS and 280° C. for sol-gel PEG-coated capillaries). The desorption was performed over the five-minute period, whereby the released analytes were swept over by the carrier gas into the GC column. The thermal desorption step was accomplished in the splitless mode, keeping the column temperature at 30° C. to promote effective solute focusing at the column inlet. After thermal desorption, the split vent remained closed throughout the course of the chromatographic run. The GC separations were performed using in-house prepared sol-gel-coated open tubular PDMS columns (10 m×0.25 mm i.d.). After the sample was introduced into the column, the column oven temperature was increased at a rate of 15° C./min. GC analysis were carried out using helium as the carrier gas. Analyte detection was performed using a flame ionization detector (FID). The FID detector temperature was maintained at 350° C.

Results and Discussion.

Sol-gel technology provides an elegant synthetic pathway to advanced materials (Novak, B. M. Adv. Mater. 1993, 5, 422-433; Livage, J. In Applications of Organometallic Chemistry in the Preparation and Processing of Advanced Materials, Harrod, J. F., Lame, R. M. Eds.; Kiuwer: Dordrecht, The Netherlands, 1995; pp. 3-25; Walsh, D.; Whiton, N. T. Chem. Mater. 1997, 9, 2300-2310) with a wide range of applications. (Aylott, J. W. et al. Chem. Mater. 1997, 9, 2261-2263; Collinson, M. M. et al. Chem. 2000, 72, 702A-709A; Lobnik, A. et al. Sens. Actuators B 1998, 51, 203-207; Vorotilov, K. A. et al. J. Sol-gel Sci. Technol. 1997, 8, 581-584; Reisfeld, R.; Jorgenson, C. K. (eds.), Spectroscopy, Chemistry, and Applications of Sol-gel Glasses, Springer-Verlag, Berlin, 1992; Lev, O. et al. S. Chem. Mater. 1997, 9, 2354-2375; Atik, M. et al., J. Sd. Gel. Sci. Technol. 1997, 8, 517-522; Haruvy, Y. et al. N. Chem. Mater. 1997, 9, 2604-2615; Fabes, B. D. et al. J. Am. Ceram. Soc. 1990, 73, 978-988; Sakka, S. et al. In Chemistry, Spectroscopy, and Applications, Reisfeld, R., Jorgenson C. K. Eds.; Springer-Verlag: Berlin, 1992; pp. 89-118). In the context of analytical microseparations, it allows for the in situ creation of hybrid organic-inorganic stationary phases within separation columns in the form of coatings, (Rodriguez, S. A. et al. Chem. Mater. 1999, 11, 754-762; Rodriguez, S. A. et al. Anal. Chem. Acta 1999, 397, 207-215; Guo Y. et al. J. Microcol. September 1995, 7, 485-491; Guo, Y. et al. Anal. Chem. 1995, 67, 2511-2516; Guo, Y. et al. Chromatographia 1996, 43, 477-483; Guo, Y. et al. J. Chromatogr. A. 1996, 744, 17-29; Narang, P. et al. J. Chromatogr. A. 1997, 773, 65-72; Hayes, J. D. et al. J. Chromatogr. B 1997, 695, 3-13; Hayes, J. D. et al. Anal. Chem. 2001, 73, 987-996) monolithic beds, (Cortes, H. J. et al. J. High. Resolut. Chromatogr./Chromatogr. Commun. 1987, 10, 446-448; Fields, S. M. Anal. Chem. 1996, 68, 2709-2712; Hayes, J. D. et al. Anal. Chem. 2000, 72, 4090-4099; Nakanishi, K. et al. J. Sol. gel. Sci. Technol. 1997, 8, 547-552; Duly, M. T. et al. Anal. Chem. 1998, 70, 5103-5107; Fujimoto, C. J. High Resol. Chromatogr. 2000, 23, 89-92; Roed, L. et al. J. Micro September 2000, 12, 561-567) and stationary phase particles. (Reynolds, K. J. et al. J. Liq. Chromatogr. & Rel. Technol. 2000, 23, 161-173; Pursch, M. et al. Chem. Mater. 1996, 8, 1245-1249) Excellent chromatographic and electromigration separations have been demonstrated using separation columns with sol-gel stationary phases. (Wang, D. X. Sol-gel Chemistry-Mediated Novel Approach to Column Technology for High-Resolution Capillary Gas Chromatography, Ph.D. Dissertation, University of South Florida, Department of Chemistry: Tampa, Fla., 2000; Wang, D. X. et al. Anal. Chem. 1997, 69, 4566-4576; Guo, Y., et al. Anal. Chem. 1995, 67, 2511-2516; Hayes, J. D. et al. J. Chromatogr. B 1997, 695, 3-13; Hayes, J. D. et al. Anal. Chem. 2001, 73, 987-996; Hayes, J. D. “Sol-Gel Chemistry-Mediated Novel Approach to Column Technology for Electromigration Separations,” Ph.D. dissertation, Department of Chemistry, University of South Florida, Tampa, Fla., USA, 2000; Tang, Q. et al. J. Chromatogr. A 1999, 837, 35-50; Cabrera, K. et al. J High Resol. Chromatogr. 2000, 23, 93-99; Chen, Z., et al. Anal. Chem. 2001, 73, 3348-3357; Roed, L. et al. J. Chromatogr. A 2000, 890, 347-353.) Applicants introduced Sol-gel coatings for gas chromatography (Wang, D. X. et al. A. Anal. Chem. 1997, 69, 4566-4576) and solid-phase microextraction (Chong, S. L. et al. Anal. Chem. 1997, 69, 3889-3898) in 1997, and demonstrated significant thermal and solvent stability advantages inherent in sol-gel coated GC columns (Wang, D. X. Sol-gel Chemistry-Mediated Novel Approach to Column Technology for High-Resolution Capillary Gas Chromatography, Ph.D. Dissertation, University of South Florida, Department of Chemistry: Tampa, Fla., 2000) and SPME fibers. (Malik, A. et al. In Applications of Solid-phase Microextraction, Pawliszyn, J. Ed.; Royal Society of Chemistry (RSC): Cambridge (UK), 1999; pp. 73-91) Since then several other groups have got involved in sol-gel research for solid phase microextraction (Gbatu, T. P. et al. Anal. Chim. Acta 1999, 402, 67-79; Wang, Z. Y. et al. J. Chromatogr. A 2000, 893, 157-168; Zeng, Z. et al. Anal. Chem. 2001, 73, 2429-2436) and solid-phase extraction. (Senevirante, J. et al. Talanta 2000, 52, 801-806).

Because of the advanced material properties, sol-gel coatings and monolithic beds can also be expected to serve as excellent extraction media in capillaries as an effective means of solventless microextraction, and call such a microextraction technique as Sol-gel Open Tubular Microextraction (OTME). Sol-gel OTME is synonymous with in-tube solid-phase microextraction (in-tube SPME) on sol-gel coated capillaries. Both sol-gel OTME and sol-gel monolithic microextration (MME) can be combined under a general term—Capillary Microextraction (CME). The new terminology provides a better reflection of the techniques, since “In-Tube Solid-phase Microextraction” is not necessary limited to the use of only “solid phases” as the extraction media. In fact, liquid stationary phase coatings are commonly used both in in-tube SPME as well as conventional SPME.

Sol-gel technology allows of the creation of coatings on the inner surface of open tubular GC, CE, and CEC columns (Wang, D. X. et al. Anal. Chem. 1997, 69, 4566-4576; Guo, Y. et al. Anal. Chem. 1995, 67, 2511-2516; Hayes, J. D. et al. Anal. Chem. 2001, 73, 987-996) as well as on the outer surface of substrates of different shapes and geometry (e.g., SPME fibers. (Chong, S. L. et al. Anal. Chem. 1997, 69, 3889-3898; Gbatu, T. P., et al. Anal. Chim. Acta 1999, 402, 67-79; Wang, Z. Y. et al. J. Chromatogr. A 2000, 893, 157-168; Zeng, Z. et al. Anal. Chem. 2001, 73, 2429-2436.). It is applicable to the creation of silica-based, (Her, R. K. The Chemistry of Silica, Wiley, New York, 1979; Brinker, C. J.; Scherer, G. W. Sol-Gel Science, Academic Press, San Diego, Calif., 1990; Rabinovich, E. M. In Sol Gel Technology for Thin Films, fibers, Pre forms, Electronics, and Specialty Shapes, Klein, L. C. Ed.; Noyes Publications: Park Ridge, N.J., 1988; pp. 260-294) and transition metal-based (Livage, J. et al. Prog. Solid. St. Chem. 1988, 18, 259-341; In, M. et al. J. Sol. gel. Sd. Technol. 1995, 5, 101-114; Jiang, Z., et al. Anal. Chem. 2001, 73, 686-688; Silva, R. B. et al. J. Sep. Sd. 2001, 24, 49-54; Palkar, V. R. Nanostructured Mater. 1999, 11, 369-374; Chaput, F. et al. J. Non. Cryst. Solids. 1995, 188, 11-18) and silica/nonsilica mixed systems. (Dutoit, D. C., et al. J. Catal. 1995, 153, 165-176; Jones, S. A. et al. Chem. Mater. 1997, 9, 2567-2576; Kosuge, K. et al. J. Phys. Chem. B1 999, 103, 3562-3569).

In the context of capillary separation and sample pre-concentration techniques, the most important attribute of sol-gel coating technology is that it provides surface coatings that become automatically bonded to the substrate surfaces containing sol-gel-active functional groups (e.g., silonal groups). This direct chemical bonding results in enhanced thermal and solvent stability of sol-gel coatings. The attributes of thermal and solvent stability of the stationary phase coatings are enormously important in analytical separation and sample pre-concentration.

Advantageously, sol-gel technology also allows for the stationary phase coating, its immobilization, and deactivation to be achieved in one single step (Wang, D. X. et al. Anal. Chem. 1997, 69, 4566-4576) instead of multiple time-consuming steps involved in conventional coating technology.

The use of the stationary phase coating on the inner surface of a fused silica capillary eliminates coating scraping problem inherent in fiber-based SPME and significantly reduces the possibility of sample contamination. Furthermore, the protective polyimide coating on the outer surface of the fused silica extraction capillary adds flexibility to the extraction device as compared with traditional SPME fibers.

Sol-gel PDMS- and PEG-coated were used in conjunction with the gravity-fed sample reservoir (FIG. 9) to develop a simple and reproducible method for the extraction of analytes form aqueous media. The aim was to make a contribution to the further development of SPME technology by using sol-gel extraction media whose advanced material properties would help to overcome some basic problems inherent either in fiber-based SPME or in-tube with conventional coatings. Current status of SPME technology clearly calls for the improvement of sample capacity of the fiber, enhancement of thermal and solvent stability of the coating, and providing better protection against mechanical damage of the coating. The present data demonstrates the possibility of addressing these shortcomings of conventional SPME via sol-gel capillary microextraction (CME).

Sol-gel capillary microextraction typically uses a short length of fused silica capillary coated internally with sol-gel stationary phase. The extraction is carried out by attaching the extraction capillary to an in-house designed gravity-fed extraction apparatus (FIG. 9). Sol-gel-coated capillary coatings are chemically bonded to the substrate, stabilizing the coating during operations that require exposure to high temperatures or organic solvents. Because of the chemical bonding, sol-gel coatings have significant stability advantage over physically held or glued coatings (Liu, Y. et al. Anal. Chem. 1997, 69, 190-195) used in SPME practice. Upelco recommends that commercial PDMS fibers should be not be exposed to non-polar organic solvents like hexane (SUPELCO Catalog 2007: Chromatography Products for Analysis and Purification, Aldrich-Sigma Co.: USA, 2001; p. 259).

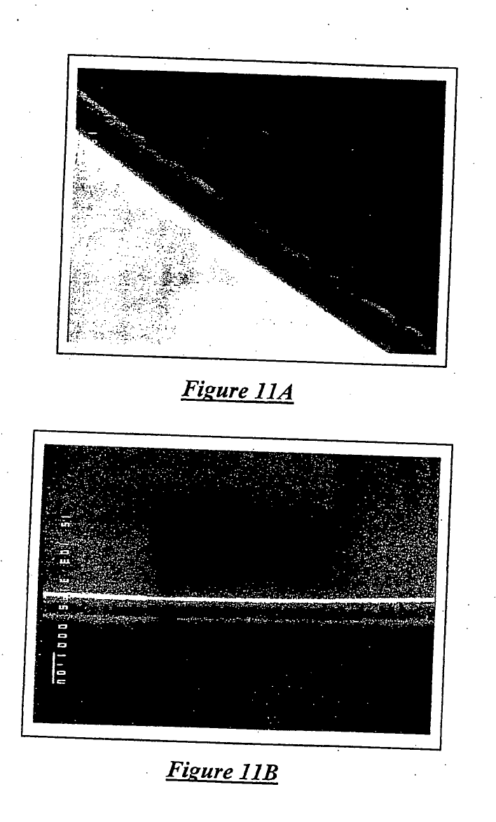

FIG. 11 represents scanning electron micrographs (SEM) illustrating the internal structures two 250 μm i.d. fused silica capillaries with sol-gel PDMS (FIG. 11A) and sol-gel PEG (FIG. 11B) coatings on the inner surface. As can be seen from these SEM images, the coatings in these microextraction capillaries are remarkably uniform in thickness. The thickness of the sol-gel PDMS coating was estimated approximately at 0.6 μm, while that for the sol-gel PEG coating at ˜0.4 μm.

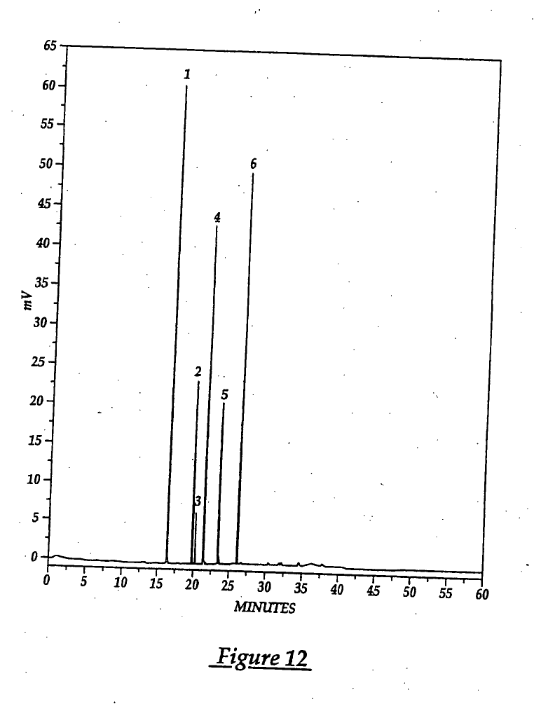

FIG. 12 and Table I present experimental data that illustrates open tubular microextraction of polycyclic aromatic hydrocarbons (PAHs) performed on an aqueous sample at ppb and sub-ppb level concentrations of the analytes using a sol-gel PDMS coated capillary. The repeatability data present in Table I shows that sol-gel OTME-GC provides excellent run-to-run repeatability in solute peak areas (less than 3%) and retention time (less than 0.2%). The data on the detection limits demonstrate high sensitivity of capillary microextraction. For example, using a flame ionization detector, the detection limit for naphthaline (peak #1 in FIG. 12) was estimated at 300 parts per quadrillion (ppq). This ppq level sensitivity of CME was obtained on a 250 μm i.d. capillary with relatively thin coating (0.6 μm).

Sol-gel coating technology can easily produce thick coatings (Chong, S. L. et al. Anal. Chem. 1997, 69, 3889-3898; Wang, Z. Y. et al. J. Chromatogr. A 2000, 893, 157-168; Zeng, Z. et al. Anal. Chem. 2001, 73, 2429-2436) (d_{f}>μm). For example, Zeng et al. recently reported SPME on sol-gel coated fibers with a coating thickness of 76 μm. The use of microextraction capillaries with thick sol-gel coatings should lead to higher sensitivity of capillary microextraction. It can be expected that the use of capillaries with larger inner diameter and thicker sol-gel coatings should lead to further enhancement of this extraction sensitivity.

In this work, the extraction capillary length was relatively short—only 3.5 cm. The use of such a short length was dictated by the linear dimensions of the glass insert of the injection port and that of the press-fit connector. In principle longer extraction capillaries can be employed using a different configuration of the coupling, between the extraction capillary and the open tubular GC column.

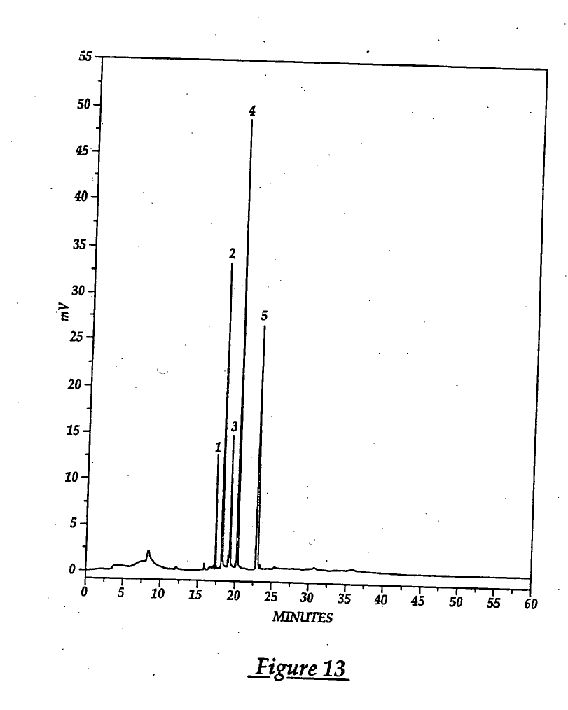

FIG. 13 represents a gas chromatogram of several free aldehydes extracted from an aqueous medium by OTME using a sol-gel PDMS coated capillary. Aldehydes are important both from the industrial, environmental, and toxicological points of view. (Koivusalmi, E. et al. Anal. Chem. 1999, 71, 86-91; Martos, P. A., et al. Anal. Chem. 1998, 70, 2311-2320). Low molecular weight aldehydes are starting material for important plastic materials. Formaldehyde represents a ubiquitous indoor air pollutant. (Koziel, J. A. et al Environ. Sci. Technol. 2001, 35, 1481-1486). Aldehydes are major disinfections by-products formed as a result of ozonation of organic contaminants in drinking water (Nawrocki, J. J. Chromatogr. A 1996, 749, 157-163; Fielding, M. et al. “Disinfection By-Products in Drinking Water”. Current Issues, Royal Society of Chemistry, Cambridge, UK, 1999), and accurate analysis of their trace-level contents is important due to their carcinogenic activities and other adverse health effects. (Guidelines for Drinking Water Quality, 2nd ed. WHO (World Health Organization): Geneva, 1993). Aldehydes are polar compounds, and their determination is often performed through derivatization into less polar and/or easy to detect forms. (Nawrocki, J. J. Chromatogr. A 25 1996, 749, 157-163; Ferioli, F. et al. Chromatographia 1995, 41, 61-65; Oesterheldt, G., et al. Anal. Chem. 1985, 321, 553-555). In various sampling and sample preparation techniques (including SPME), the derivatization step is often performed in situ—right on the active matrix of the sampling device. (Zhang, J. et al. Environ. Sci. Technol. 2000, 34, 2601-2607). In SPME, this step is carried out on the fiber coating loaded with the derivatizing reagent. Derivatization often results in better affinity of the derivatized forms of the polar analytes (compared with their underivatized forms) for the organic phase on the fiber and reduces solute adsorption on the chromatographic column used for their subsequent analysis.

In this work, aldehydes were extracted and analyzed without derivatization. This became possible due to outstanding material properties of sol-gel PDMS coating used both in the microextraction capillary as well as in the GC separation column. Organic-inorganic nature of the sol-gel PDMS coating provides sorption sites both of the polar and non-polar analytes. High quality of column deactivation achieved through sol-gel column technology (Wang, D. X. et al. Anal. Chem. 1997, 69, 4566-4576) allows the GC analysis of aldehydes without derivatization. From an analytical standpoint, the possibility of extraction and gas chromatographic analysis of underivatized aldehydes by OEME-GC is important and should provide simplicity, speed, sensitivity, and accuracy in aldehyde analysis.

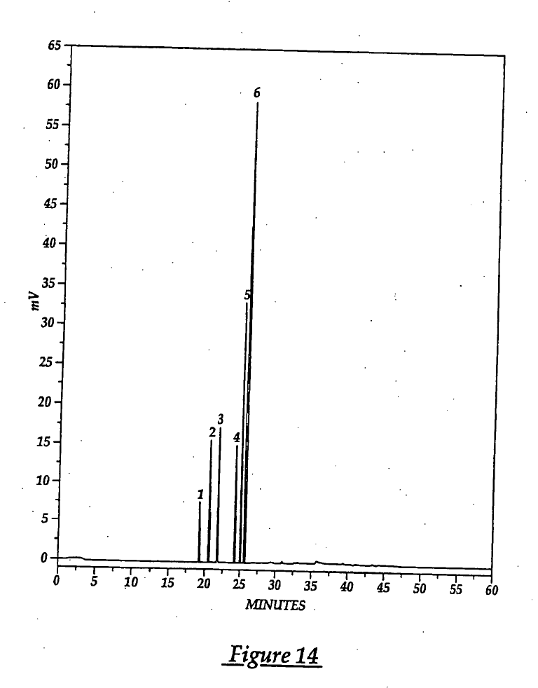

FIG. 14 represents a gas chromatogram illustrating OTMEGC analysis of several ketones extracted from an aqueous sample using a sol-gel coated PDMS capillary. Like aldehydes, ketones are also often derivatized for analysis, (Zhang, J. et al. Environ. Sci. Technol. 2000, 34, 2601-2607; Buldt, A. et al. Anal. Chem. 1999, 71, 1893-1898) especially by HPLC. Using sol-gel coated extraction capillary and separation column, no derivatization step was necessary either at the extraction or the separation step. Two important features can be observed in this chromatogram. First, the peaks are sharp and symmetrical, which is indicative of effective focusing of the analytes at column inlet after their desorption as well as excellent performance of the sol-gel PDMS column used for the separation. Second, although all analyte concentrations in the aqueous sample were practically the same (100 ppb), the analyte peak height increased with the increase of the molecular weight of the ketone. This might be the consequence of two distinctive phenomena: (1) higher loss of the more volatile ketones during the post-extraction purging step of the microextraction capillary, and (2) displacement of the lower molecular weight ketones by the ones with higher molecular weights. (Pawliszyn, J. J. Chromatogr. Sci. 2000, 15 37, 270-270.) However, considering the fact that the analyte concentrations were sufficiently low (100 ppb), and that sol-gel coatings are characterized by enhanced surface area, (Chong, S. L. et al. Anal. Chem. 1997, 69, 3889-3898) it is not likely that the coating was overloaded at this concentration level. So, it is more likely that the peak size discrimination of the ketones was caused primarily by the first factor.

The, sol-gel OTME-GC for aldehydes and ketones described herein provides a number of important advantages over sample preparation techniques coupled to HPLC. First, the fact that no derivatization is needed makes the procedure faster, simpler, and more accurate. Second, since the flame ionization detector used for GC analysis inherently possess several order of magnitude higher sensitivity compared with the UV detector commonly used with the HPLC analysis, the described procedure also provides sensitivity advantage. The OTME-GC analysis of the aldehydes and ketones is also characterized by low run-to-run RSD values (Table II). For five replicate measurements, RSD values of under 6% and 0.4% were obtained for solute peak area and retention time, respectively, the only exception was benzaldehyde that had a retention time RSD value of 1.9% which is significantly higher than the RSD values for the rest of the aldehydes and ketones studied.

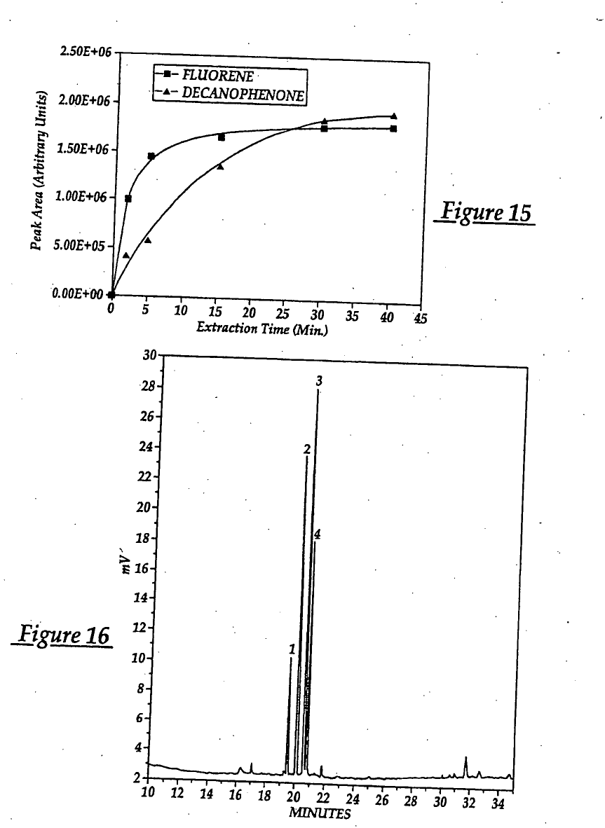

FIG. 15 illustrates the extraction kinetics of fluorene (a non-polar analyte) and decanophenone (a moderately polar analyte) on a sol-gel PDMS coated microextraction capillary. The extraction was carried out using an aqueous sample containing 1 ppm concentration of each analyte. As can be seen from FIG. 15, the extraction equilibrium for fluorene was practically reached after 15 minutes of extraction while for decanophenone it required about 35 minutes of extraction to reach the plateau on the extraction curve. Such differences in the extraction behavior of the two analytes can be explained based on the differences in their hydrophobilicity. Highly non-polar nature of fluorene makes it more susceptible to hydrophobic interaction and facilitates its extraction by the non-polar PDMS moieties on the sol-gel coating. This is evident from the steeply rising beginning part of the fluorene extraction curve in FIG. 15. Higher polarity of the ketone makes it more hydrophilic which leads to a slower extraction process as is evidenced by the more gradually rising nature of the extraction curve of the ketone.

Highly polar compounds, such as alcohols, amines, and phenols, have higher affinity for water. Conventional non-polar phases (e.g., PDMS) are usually not very efficient for their extraction from an aqueous phase. Polar coatings are normally, used for the extraction of these highly polar analytes. However, creation of thick coatings of polar stationary phases and their immobilization on a substrate are associated with technical difficulties. (Janak, K. et al. J. Microcol. September 1991, 3, 115-120). Previously, Applicants showed (Chong, S. L. et al Anal Chem. 1997, 69, 3889-3898; Janak, et al. 1991) that these polar compounds can be satisfactorily extracted and analyzed using sol-gel PDMS coatings. This becomes possible thanks to the organic-inorganic hybrid nature of the sol-gel PDMS coatings characterized by the presence of both polar and non-polar sorption sites. Sol-gel coating technology allows for the creation of both polar (Hayes, J. D. et al. J. Chromatogr. B 1997, 695, 3-13; Wang, Z. Y. et al. J. Chromatogr. A 2000, 893, 157-168) and non-polar (Chong et al. 1997; Gou et al., 2000; Wang, D. X. 2000; Wang, D. X. et al. 1997; Hayes, J. D., et al. 2001; Malik et al. 1999; Gbatu, T. P. et al. 1999) coatings with equal ease and versatility. In the present work, we demonstrate the possibility of efficient extraction of these polar analytes from an aqueous environment using open tubular capillary microextraction on sol-gel polyethylene glycol (sol-gel PEG) coatings.

FIG. 16 represents OTME-GC analysis of phenolic compounds at low ppb level concentrations using a sol-gel PEG coated microextraction capillary. A sol-gel PEG coated capillary column was used for the GC analysis. The analysis of phenols is important from an environmental point of view since some phenols are registered in US EPA's priority pollutant list. (EPA Method 604. Phenols in Federal Register, Environmental Protection Agency: Friday, Oct. 6, 1984; pp. 58-66). The extraction and GC analysis was done without derivatization, although analysis of polar compounds often require derivatization. (Li, D. et al. Anal. Chem. 2001, 73, 3089-3095; Zapt, A. et al. J. High Resol. Chromatogr. 1999, 22, 83-88; Koster, E. H. et al. J. Sep. Sci. 2001, 24, 116-122). Under the used experimental conditions, the detection limit for this analysis was 10 ppt. The sharp symmetrical peaks and the low detection limits obtained are indicative of high extraction efficiency of the sol-gel PEG coated microextraction capillary and excellent analytical performance of the used sol-gel PEG column. Conventional coatings for the analysis of phenols often show carryover problems (Buchholz, K. D. et al. J. Anal. Chem. 1994, 66, 160-167) because of the strong interaction of polar analytes with the coatings. Effective release of the extracted polar analytes for the coatings require application of high desorption temperature. However, relatively low thermal stability of conventionally prepared thick coatings do not allow of the application of high temperatures during the analyte desorption steps of the analysis, resulting in only partial release to the extracted analytes. This incomplete desorption of the extracted analytes gives rise to the carryover problem. The sol-gel PEG-coated extraction capillary showed consistent performance at a desorption temperature of 300° C. No carryover problems were observed for polar or non-polar analytes on sol-gel PEG as well as sol-gel PDMS coated microextraction capillaries.

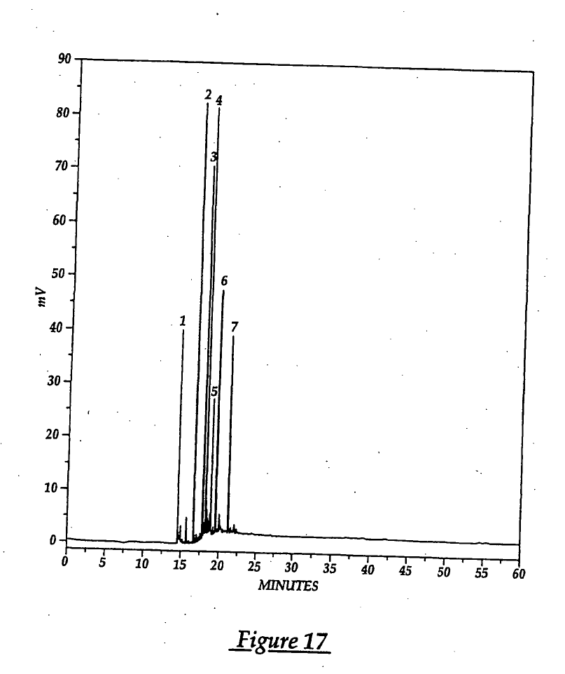

FIG. 17 illustrates a gas chromatogram of a mixture of alcohols and amines that were extracted from an aqueous medium using a sol-gel PEG coated microextraction papillary. The analytes were at 10 ppb concentration level in the aqueous sample. No derivatization was needed either for extraction or for GC analysis of these highly polar compounds. Excellent peak shapes, detection sensitivity, and extraction efficiency is evident from the chromatographic data presented in FIG. 12 and Table II. The run-to-run repeatability data for the phenols, alcohols and amines, presented in Table II in terms of peak area and retention time RSD values, are also remarkable. For these highly polar analytes, the peak area and retention time RSD values were less than 4.5% and 0.2%, respectively.

The capillary-to-capillary reproducibility for open tubular microextraction was evaluated for the two types of sol-gel coatings used in this work—sol-gel PDMS and sol-gel PDMS and sot-gel PEG coatings. For this, three identical segments of each type of sol-gel coated capillary were used for extraction. Fluorene was used at the test solute for the sol-gel PDMS coated capillary while decanophenone served the same purpose for the sol-gel PEG coated microextraction capillary. A total of six extractions (30 min each) were carried out on each capillary using 1 ppm aqueous solutions containing the respective test solute. The relative standard deviations (RSD) of the mean GC peak area for the two test solute on sol-gel PDMS and sol-gel PEG capillaries were 3.9% and 3.0%, respectively. These low RSD values are indicative of excellent capillary-to-capillary reproducibility in sol-gel open tubular micro extraction.

In the present work, OTME was performed using 3.5 cm long sol-gel coated capillary segments. The length of the used extraction capillary was limited by the linear dimensions of the glass insert in the injection port of the used GC (Varian 38000) and the length of the two-way press-fit connector. In this format, the entire length of the extraction capillary was contained inside the GC injection port. However, sol-gel coated capillary segments of greater lengths can be used in GC systems that employ longer glass inserts, (e.g., Shimadzu 17) which should lead to enhanced sensitivity. Even in the present configuration, the coated segment was more than three times longer than coated segments used on conventional SMPE fibers. The desorption of the extracted analytes can be achieved by making a press-fit connection between the extraction capillary and the GC column outside the injection port. (Koivusalmi, E. et al Anal. Chem. 1999, 71, 86-91) Such a configuration will also allow for the use of sol-gel coated capillaries of greater lengths, significantly enhancing the sensitivity of the technique.

For the first time, sol-gel coated capillaries were used for solventless microextraction and sample pre-concentration, and the technique was termed sol-gel capillary microextraction (sol-gel CME). Two types of sol-gel coatings (sol-gel PDMS and sol-gel PEG) were effectively used for the extraction of analytes belonging to various chemical classes. Parts per trillion (ppt) and parts per quadrillion (ppq) level detection sensitivities were achieved for polar and non-polar analytes. Further sensitivity enhancements should be possible through the use of thicker sol-gel coatings in conjunction with longer extraction capillaries of larger inner diameter. The sol-gel coated capillaries are characterized by enhanced thermal and solvent stabilities (a prerequisite for efficient analyte desorption), making them very suitable for coupling with both GC and HPLC. Sol-gel capillary microextraction showed remarkable run-to-run and capillary-to-capillary repeatability, and produced peak area RSD values of less than 6% and 4% respectively.

Experimentation Series 3

Equipment. All CME-GC experiments were performed on a Shimadzu Model 14A capillary GC system equipped with a flame ionization detector (FID) and a split-splitless injector. On-line data collection and processing were done using ChromPerfect (version 3.5) computer software (Justice Laboratory Software, Denville, N.J.). A Fisher Model G-560Vortex Genie 2 system (Fisher Scientific, Pittsburgh, Pa.) was used for thorough mixing of various sol solution ingredients. A Microcentaur model APO 5760 microcentrifuge (Accurate Chemical and Scientific Corp., Westbury, N.Y.) was used to separate the sol solution from the precipitate (if any) at 13,000 rpm (15,682×g). A Nicolet model Avatar 320 FTIR instrument (Thermo Nicolet, Madison, Wis.) was used to acquire infrared spectra of the prepared sol-gel materials. A Bamstead Model 04741 Nanopure deionized water system (Barnstead/Thermodyne, Dubuque, Iowa) was used to obtain ˜16.0MΩ water. Stainless steel mini-unions (SGE Inc., Austin, Tex.) were used to connect the fused silica capillary GC column with the microextraction capillary, also made of fused silica. An in-house-designed liquid sample dispenser was used to facilitate gravity-fed flow of the aqueous sample through the sol-gel microextraction capillary. A homebuilt, gas pressure-operated capillary filling/purging device (Hayes, J.; Malik, J. Chromatogr. B. 1997, 695, 3-13) was used to perform a number of operations: (a) rinse the fused silica capillary with solvents; (b) fill the extraction capillary with the sol solution; (c) expel the sol solution from the capillary at the end of sol-gel coating process; and (d) purge the capillary with helium after treatments like rinsing, coating, and sample extraction.

Chemicals and materials. Fused-silica capillary (320 and 250 μm, i.d.) with a protective polyimide coating was purchased from Polymicro Technologies Inc. (Phoenix, Ariz.). Naphthalene and HPLC-grade solvents (methylene chloride, methanol) were purchased from Fisher Scientific (Pittsburgh, Pa.). Hexamethyldisilazane (HMDS), poly (methylhydrosiloxane) (PMHS), ketones (valerophenone, hexanophenone, heptanophenone, and decanophenone), aldehydes (nonylaldehyde, n-decylaldehyde, undecylic aldehyde, and dodecanal), polycyclic aromatic hydrocarbons (PAHs) (naphthalene, acenaphthene, fluorene, phenanthrene, pyrene, and naphthacene), were purchased from Aldrich (Milwaukee, Wis.). Two types of silanol-terminated poly(dimethyldiphenylsiloxane) (PDMDPS) copolymers (with 2-3% and 14-18% contents of the diphenyl-containing component) were purchased from United Chemical Technologies Inc. (Bristol, Pa.).

Preparation of sol-gel zirconia-PDMDPS coating. The sol solution was prepared in a clean polypropylene centrifuge tube by dissolving the following ingredients in a mixed solvent system consisting of methylene chloride and butanol (250 μL each): 10-15 μL of zirconium(IV) butoxide (80% solution in 1-butanol), 85 mg of silanol-terminated poly(dimethyldiphenylsiloxane) copolymer, 70 mg of poly(methylhydrosiloxane), 10 μL of 1,1,1,3,3,3-hexamethyldisilazane, and 2-4 μL of glacial acetic acid. The dissolution process was aided by thorough vortexing. The sol solution was then centrifuged at 13,000 rpm (15,682×g) to remove the precipitate (if any). The top clear sol solution was transferred to a clean vial and was further used in the coating process. A hydrothermally treated fused silica capillary (2 m) was filled with the clear sol solution, using pressurized helium (50 psi) in the filling/purging device (Hayes, J.; Malik, J. Chromatogr. B. 1997, 695, 3-13). The sol solution was allowed to stay inside the capillary for a controlled period of time (typically 15-30 min) to facilitate the formation of a sol-gel coating and its chemical bonding to the capillary inner walls. After that, the free portion of the solution was expelled from the capillary, leaving behind a surface-bonded sol-gel coating within the capillary. The sol-gel coating was then dried by purging with helium. The coated capillary was further conditioned by temperature programming from 40 to 150° C. at 1° C./min and held at 150° C. for 300 min. Following this, the conditioning temperature was raised from 150 to 320° C. at 1° C./min and held at 320° C. for 120 min. The extraction capillary was further cleaned by rinsing with 3 mL of methylene chloride and conditioned again from 40° C. to 320° C. at 4° C./min. While conditioning, the capillary was constantly purged with helium at 1 mL/min. The conditioned capillary was then cut into 10 cm long pieces that were further used to perform capillary microextraction.

Preparation of the samples. PAHs, ketones, and aldehydes were dissolved in methanol or tetrahydrofuran to prepare 0.1 mg/L stock solutions in silanized glass vials. For extraction, fresh samples with ppb level concentrations were prepared by diluting the stock solutions with deionized water.

Gravity-fed sample dispenser for capillary microextraction. The gravity-fed sample dispenser for capillary microextraction was constructed by in-house modification of a Chromaflex AQ column (Kontes Glass Co., Vineland, N.J.) consisting of a thick-walled glass cylinder coaxially placed inside an acrylic jacket. The inner surface of the thick-walled cylindrical glass column was deactivated by treating with a 5% (v/v) solution of HMDS in methylene chloride followed by overnight heating at 100° C. The column was then cooled to ambient temperature, thoroughly rinsed with methanol and liberal amounts of deionized water, and dried in a helium flow. The entire Chromaflex AQ column was subsequently reassembled.

Sol-gel capillary microextraction-GC analysis. To perform capillary microextraction, a previously conditioned sol-gel zirconia-PDMDPS coated microextraction capillary (10 cm×320 μm i.d. or 10 cm×250 μm i.d.) was vertically connected to the bottom end of the empty sample dispenser. The aqueous sample (50 mL) was then placed in the dispenser from the top and allowed to flow through the microextraction capillary under gravity. While passing through the extraction capillary, the analyte molecules were sorbed by the sol-gel zirconia-PDMDPS coating residing on the inner walls of the capillary. The sample flow through the capillary was allowed to continue for 30-40 min for an extraction equilibrium to be established. After this, the microextraction capillary was purged with helium at 25 kPa for 1 min and connected to the top end of a vertically placed two-way mini-union connecting the microextraction capillary with the inlet end of the GC column. Approximately, 6.5 mm of the extraction capillary remained tightly inserted into the connector, as did the same length of GC column from the opposite side of the mini-union facing each other within the connector. The installation of the capillary was completed by providing a leak-free connection at the bottom end of the GC injection port so that 9 cm of the extraction capillary remained inside the injection port. The extracted analytes were then thermally desorbed from the capillary by rapidly raising the temperature of the injector (up to 300° C. starting from 30° C.). The desorption was performed over a 8.2 min period in the splitless mode allowing the released analytes to be swept over by the carrier gas into the GC column held at 30° C. during the entire desorption process. Such a low column temperature facilitated effective solute focusing at the column inlet. Following this, the column temperature was programmed from 30 to 320° C. at a rate of 20° C./min. The split vent remained closed throughout the entire chromatographic run. Analyte detection was performed using a flame ionization detector (FID) maintained at 350° C.

Result and Discussion

Capillary microextraction (Bigham, S.; Kabir, A. et al. Anal Chem. 2002, 74, 752) uses a sorbent coating on the inner surface of a capillary and thereby, overcomes a number of deficiencies inherent in conventional fiber-based SPME such as susceptibility of the sorbent coating to mechanical damage due to scraping during operation, fiber breakage, and possible sample contamination. In CME, the sorbent coating is protected by the fused silica tubing against mechanical damage. The capillary format of SPME also provides operational flexibility and convenience during the microextraction process since the protective polyimide coating on the outer surface of fused silica capillary remains intact. Inner surface-coated capillaries provide a simple way to perform extraction in conjunction with a gravity-fed sample dispenser and thus, avoid typical drawbacks of fiber-based SPME, including the need for sample agitation during extraction as well as the sample loss and contamination problems associated with this.

The sol-gel process is a straightforward route to obtaining homogeneous gels of desired compositions. In recent years, it has received increased attention in analytical separations and sample preparations due to its outstanding versatility and excellent control over properties of the created sol-gel materials that proved to be promising for use as stationary phases and extraction media.

A general procedure for the creation of sol-gel stationary phase coating on the inner walls of fused silica capillary GC columns was first described by Malik and co-workers (Wang, D.; Chong, S. L.; Malik, A.; Anal Chem. 1997, 69, 4566). In the present work, a judiciously designed sol solution ingredients (Table III) was used to create the sol-gel zirconia-PDMDPS coating on the fused silica capillary inner surface. Zirconium(IV) butoxide (80% solution in 1-butanol) was used as a sol-gel precursor and served as a source for the inorganic component of the sol-gel organic-inorganic hybrid coating.

The sol-gel zirconia-PDMDPS coating presented here was generated via two major reactions: (1) hydrolysis of a sol-gel precursor, zirconium(IV) butoxide; and (2) polycondensation of both the precursor and hydrolysis products between themselves and other sol-gel-active ingredients in the coating solution, including silanol-terminated PDMDPS. The hydrolysis of the zirconium(IV) butoxide precursor is represented by Scheme 1 (Yoldas, B. E. J. Non-Cryst. Solid, 1984, 63, 145).

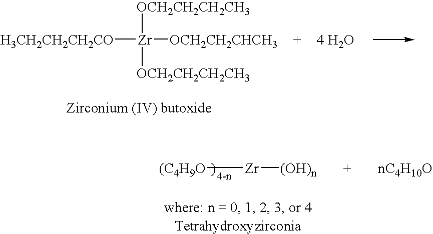

Condensation of the sol-gel polymer growing in close vicinity of the capillary walls with silanol group on the capillary surface led to the formation of an organic-inorganic coating chemically anchored to the capillary inner walls (Scheme 2).

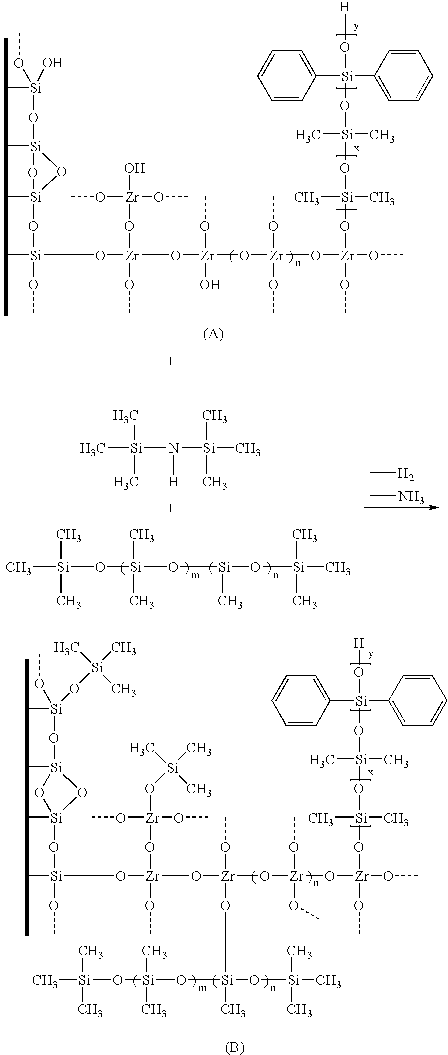

A major obstacle to preparing zirconia-based sol-gel materials using zirconium alkoxide precursors (e.g., zirconium butoxide) is the very rapid sol-gel reaction rates for these precursors. Even if the solution of zirconium alkoxide is stirred vigorously, the rates of these reactions are so high that large agglomerated zirconia particles precipitate out immediately when water is added (Chang, C. H.; Gopalan, R.; Lin, Y. S. J. Membr. Sci. 1994, 91, 27). Such fast precipitation makes it difficult to reproducibly prepare zirconia sol-gel materials. Ganguli and Kundu (J. Mater. Sci. Lett. 1984, 3, 503) addressed the fast precipitation problem by dissolving zirconium propoxide in a non-polar dry solvent like cyclohexane. The hydrolysis was performed by exposing the coatings prepared from the solution to atmospheric moisture. Heating to 450° C. was necessary to obtain transparent films. The hydrolysis rates of zirconium alkoxides can also be controlled by chelating with ligand-exchange reagents. Acetic acid (Kandu, D; Biswas, P. K.; Ganguli, D. Thin Solid Films, 1988, 163, 273; Noonan, G. O.; Ledford, J. S. Chem. Mater 1995, 7, 1117), valeric acid (Severin, K. G.; Ledford, J. S.; Torgerson, B. A.; Berglund, K. A. Chem. Mater., 1994, 6, 890), β-diketones (Percy, M. J., Barlett, J. R., Spiccia, L., West, B. O., Woolfrey, J. L. J. Sol-Gel Sci. Technol. 2000, 19, 315; Peshev, P.; Slavova, V. Mater. Res. Bull. 1992, 27, 1269; Papet, P.; Le Bars, N.; Baumard, J. F.; Lecomte, A.; Dauger, A. J. Mater. Sci. 1989, 24, 3850), triethanolamine (Okubo, T.; Takahashi, T; Sadakata, M.; Nagamoto, H. J. Membr. Sci. 1996, 118, 151), and 1,5-diaminopentane (Percy, M. J., Barlett, J. R., Spiccia, L., West, B. O., Woolfrey, J. L. J. Sol-Gel Sci. Technol. 2000, 19, 315) have been used as chelating reagents for zirconia sol-gel reactions. In general, chelation occurs when the added reagent replaces one or more alkoxy groups forming a strong bond. The formation of this bond reduces the hydrolysis rate by decreasing the number of available alkoxy groups (Bradley, D. C.; Mehrotra, R. C.; Gaur, D. P. Metal Alkoxide, Academic Press, London, 1978, p. 162).

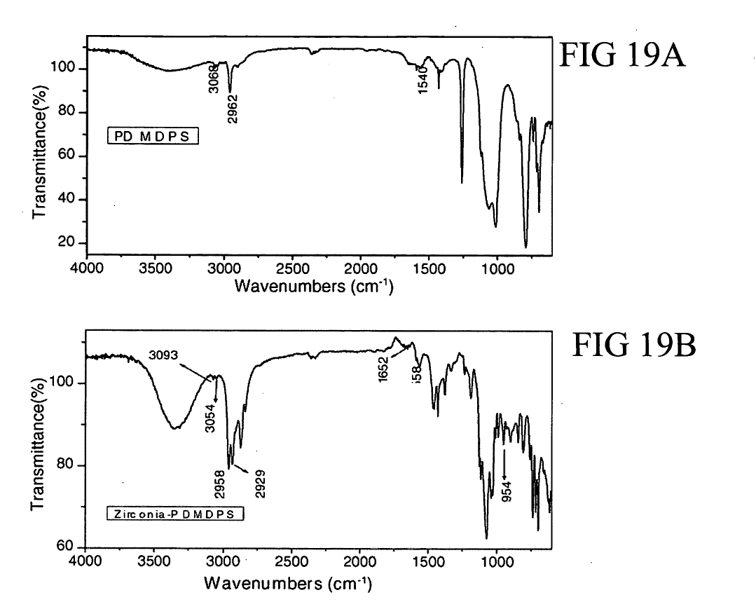

In experimentation series 3, the hydrolysis rate of zirconium butoxide was controlled by using glacial acetic acid (Wu, J. C. S.; Cheng, L. C. J. Membr. Sci. 2000, 167, 253) as a chelating agent as well as a source of water released slowly through the esterification with 1-butanol (Guizard, C.; Cygankiewicz, N.; Larbot, A.; Cot, L. J. Non-Cryst. Solids 1986, 82, 86; Larbot, A.; Alary, J. A.; Guizard, C.; Cot, L.; Gillot, J. J. Non-Cryst. Solids 1988, 104, 161). Two silanol-terminated poly (dimethyldiphenylsiloxane) copolymers (with 2-3% and 14-18% diphenyl-containing blocks) were used as sol-gel-active organic components to be chemically incorporated in the sol-gel network through polycondensation reactions with the zirconium butoxide precursor and its hydrolysis products. An IR spectrum of the pure co-polymers (the one with 2-3% phenyl-containing block) is presented in FIG. 19A where as a small stretching at 3068 cm⁻¹ indicates the presence of phenyl groups.

This advantageous chemical incorporation of an organic component into the sol-gel network is responsible for the formation of an organic-inorganic hybrid material system that can be conveniently used for in situ creation of surface coating on a substrate like the inner walls of a fused silica capillary. Besides, the organic groups help to reduce the shrinkage and cracking of the sol-gel coating (Thouless, M.D.; Olsson, E.; Gupta, A. Acta Metall. Mater., 1992, 40, 1287; Paterson, M. J. McCulloch, D. G.; Paterson, P. J. K.; Ben-Nissan, B. Thin Solid Film, 1997, 311, 196). Furthermore, the sol-gel process can be used to control the porosity and thickness of the coating and to improve its mechanical properties (Sorek, Y.; Reisfeld, R.; Weiss, A.M. Chem. Phys. Lett. 1995, 244, 371). Poly(methylhydrosiloxane) and 1,1,1,3,3,3-hexamethyldisilazane served as deactivation reagents to perform chemical derivatization of the strongly adsorptive residual hydroxyl groups on the resulting sol-gel material. These reactions minimized the strong adsorptive interactions between polar solutes and the sol-gel sorbent that may lead to sample loss, peak tailing, sample carry-over and other deleterious effects. In the presented method for the preparation of the sol-gel zirconia coated microextraction capillary, the deactivation reactions were designed to take place mainly during thermal conditioning of the capillary following the sol-gel coating procedure.

Hydrolytic polycondensation reactions for sol-gel-active reagents are well established in sol-gel chemistry (Puccetti, G.; Leblanc, R. M. J. Phys. Chem. B 1998, 102, 9002; Golubko, N. V.; Yanovskaya, M. I.; Romm, I. P.; Ozerin, A. N. J. Sol-Gel Sci. Technol 2001, 20, 245; Brinker, C.; Scherer, G. Sol-gel Science, The Physics and Chemistry of Sol-Gel Processing, Academic Press, San Diego, USA, 1990; Dire, S.; Campostrini, R.; Ceccato, R. Chem. Mater., 1998, 10, 268) and constitute the fundamental mechanism in sol-gel synthesis. The condensation between sol-gel-active zirconia and silicon compounds is also well documented (Mori, T.; Yamamura, H.; Kobayashi, H.; Mitamura, T. J. Am. Ceram. Soc. 1992, 75, 2420; Toba, M.; Mizukami, F.; Niwa, S. I.; Sano, T.; Maeda, K.; Annila, A.; Komppa, V. J. Mol. Catal., 1994, 94, 85; Zhan, Z.; Zeng, H. C. J. Non-Cryst. Solids, 1999, 243, 26). According to published literature data (Dang, Z.; Anderson, B. G., Amenomiya, Y.; Morrow, B. A. J. Phys. Chem. 1995, 99, 14437; Guermeur, C.; Lambard, J.; Gerard, J.-F.; Sanchez, C. J. Mater. Chem. 1999, 9, 769), the characteristic IR band for Zr—O—Si bonds is located in the vicinity of 945-980 cm⁻¹. FIG. 19B shows an IR spectrum of sol-gel zirconia PDMDPS material prepared by using a PDMDPS polymer containing approximately eight time higher amounts of the phenyl group than that presented in FIG. 19A. The presence of the stretching at 954 cm⁻¹ indicates the presence of Zr—O—Si bonds in the prepared sol-gel material (Dang, Z.; Anderson, B. G., Amenomiya, Y.; Morrow, B. A. J. Phys. Chem. 1995, 99, 14437).

Metal-bound hydroxyl groups on the created sol-gel coating represent strong adsorptive sites for polar solutes. In the context of analytical microextraction or separation, the presence of such groups is undesirable and may lead to a number of deleterious effects including sample loss, reproducibility problems, sample carryover problems, and peak distortion and tailing. Therefore, appropriate measures need to be taken to deactivate these adsorptive sites. This may be accomplished by chemically reacting the hydroxyl groups with suitable derivatization reagents. Like silica-based sol-gel coatings, the surface hydroxyl groups of sol-gel zirconia coating can be derivatized using reactive silicon hydride compounds such as alkyl hydrosilanes (Fadeev, A. Y.; Helmy, R.; Marcinko, S. Langmuir 2002, 18, 7521; Marcinko, S.; Helmy, R.; Fadeev, A. Y. Langmuir 2003, 19, 2752) and hexamethyldisilazane (Wu, N. L.; Wang, S. Y.; Rusakova, I. A. Science 1999, 285, 1375). A mixture of polymethylhydrosiloxane and hexamethyldisilazane was utilized for this purpose: the underlying chemical reactions are schematically represented in Scheme 2¹ (A and B) illustrate the chemical structure of the sol-gel zirconia surface coating before and after deactivation, respectively.

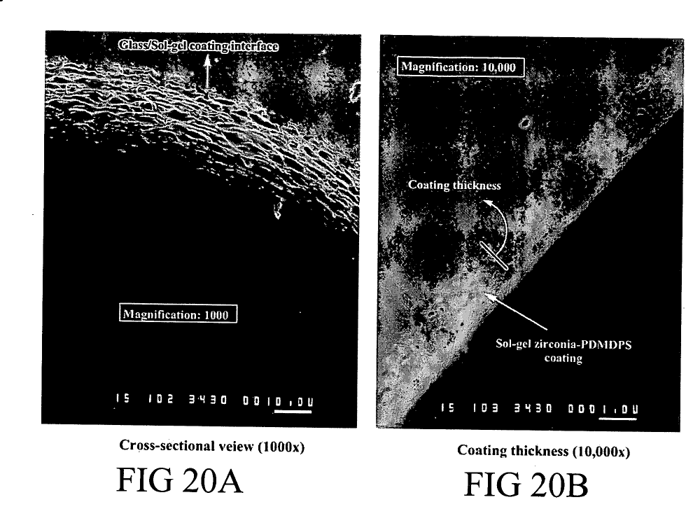

One of the most important undertakings in CME is the creation of a stable, surface-bonded sorbent coating on the inner walls of a fused silica capillary. FIGS. 20A and 20B represent scanning electron microscopic images of a sol-gel zirconia-PDMDPS coated fused silica capillary prepared according to the subject methods. The SEM images 20A and 20B were obtained at a magnification of 1000 and 10,000×, respectively. The microstructural details revealed in these images clearly show that the created sol-gel zirconia coating possesses a porous make-up which substantially differs from that of sol-gel titania coating (Kim, T. Y.; Alhooshani, K.; Kabir, A.; Fries, D. P.; Malik, A. J. Chromatogr. A. 2004, 1047, 165).

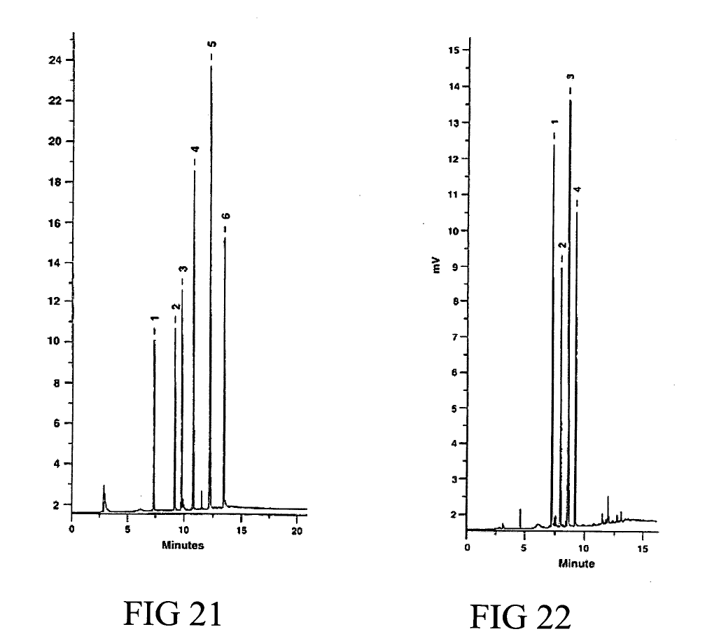

Sol-gel zirconia-PDMDPS-coated capillaries allowed the extraction of analytes belonging to various chemical classes. Experimental data highlighting CME-GC analysis of polycyclic aromatic hydrocarbons using a sol-gel zirconia-PDMDPS coated capillary is shown in FIG. 21.

CME-GC experiments were performed on an aqueous sample with low ppb level analyte concentrations. Experimental data presented in Table IV shows that CME-GC with a sol-gel zirconia-PDMDPS coating provides excellent run to-run repeatability in solute peak areas (3-7%) and the used sol-gel GC column provided excellent repeatability in retention times (less than 0.2%). It should be pointed out that the column used for GC analyses was also prepared in-house using a sol-gel method described in a previous publication (Wang, D.; Chong, S. L.; Malik, A. Anal. Chem. 1997, 69, 4566).

The reproducibility of the newly developed method for the preparation of sol-gel hybrid organic-inorganic zirconia coated capillaries was evaluated by preparing three sol-gel zirconia PDMDPS-coated capillaries in accordance with the methods of the present invention and following their performance in CME-GC analysis of different classes of analytes extracted from aqueous samples. The GC peak area obtained for an extracted analyte was used as the criterion for capillary-to-capillary reproducibility, which ultimately characterizes the capillary preparation method reproducibility. The results are presented in Table V. For each analyte, four replicate extractions were made on each capillary and the mean of the four measured peak areas was used in Table V for the purpose of capillary-to-capillary reproducibility. The presented data show that the capillary-to-capillary reproducibility is characterized by an RSD value of less than 5.5% for all three classes of compounds used for this evaluation. For a sample preparation method, a less than 5.5% R.S.D. is indicative of excellent reproducibility.

FIG. 22 illustrates a gas chromatogram of several free aldehydes extracted from an aqueous sample using a sol-gel zirconia-PDMDPS coated capillary. Here, the concentrations of the used aldehydes were in 80-500 ppb range. The extraction was carried out on a 10 cm×0.32 mm i.d. sol-gel zirconia-PDMDPS coated microextraction capillary for 30-40 min. The extraction of the analytes was performed at room temperature. Aldehydes are known to have toxic and carcinogenic properties, and therefore, their presence in the environment is of great concern because of their adverse effects on public health and vegetation (WHO, Air Quality Guidelines for Europe, WHO European, Series No. 23, Copenhagen, Denmark, 1987). Aldehydes are major disinfection by products formed as a result of chemical reaction between disinfectant (ozone or chlorine) and organic compounds in drinking water (Cancho, B.; Ventura, F.; Galceran, M. T. J. Chromatogr. A 2002, 943, 1). Therefore, accurate analysis of trace-level contents of aldehyde in the environment and in drinking water is important (Guidelines for Drinking Water Quality, second ed., WHO, Geneva, 1993). Aldehydes are polar compounds that are often derivatized (Nawrocki, J; Kalkowska, I.; Dabrowska, A. J. Chromatogr. A 1996, 749, 157) for GC analysis to avoid undesirable adsorption that causes peak tailing. Sol-gel zirconia-PDMDPS coated capillary provided highly efficient extraction of the aldehydes, and the used sol-gel GC column provided excellent peak shapes, which is also indicative of the high quality of deactivation in the used sol-gel GC column. This also demonstrates effective focusing of the analytes at the column inlet after their thermal desorption from the microextraction capillary. For the aldehydes, sol-gel CME-GC with the zirconia-PDMDPS coated capillary provided excellent repeatability in peak area (R.S.D.<5%) and retention time (R.S.D.<0.16%).

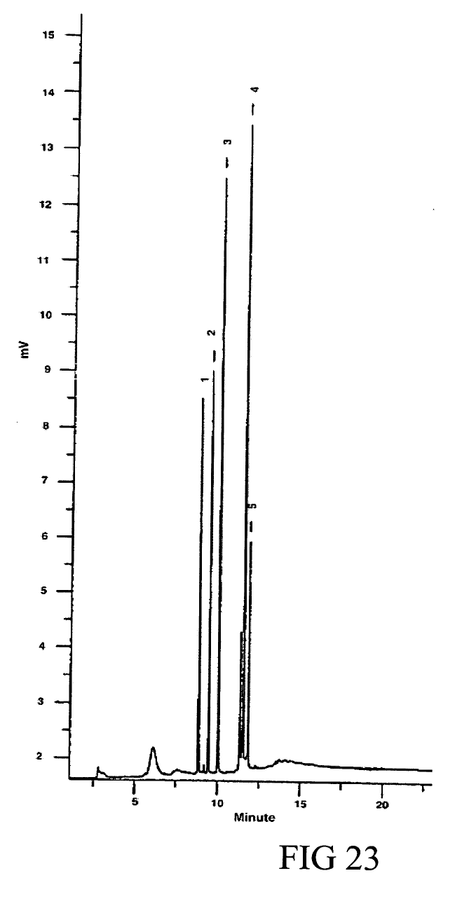

FIG. 23 shows a gas chromatogram illustrating CME-GC analysis of several ketones extracted from an aqueous sample. Like aldehydes, there was no need for derivatization of the ketones, either during extraction or GC analysis. Sharp and symmetrical GC peaks, evident from the chromatogram, show the effectiveness of the used CME-GC system, as well as the practical utility of the mini-union metal connector providing leak free connection between the extraction capillary and the GC column. Excellent reproducibility was achieved in CME-GC of ketones using sol-gel zirconia-PDMDPS coated capillary as shown in Table IV. The peak area RSD % values for ketones were less than 5.6%, and their retention time repeatability on used sol-gel PDMS column was characterized by R.S.D. values of less than 0.27%.

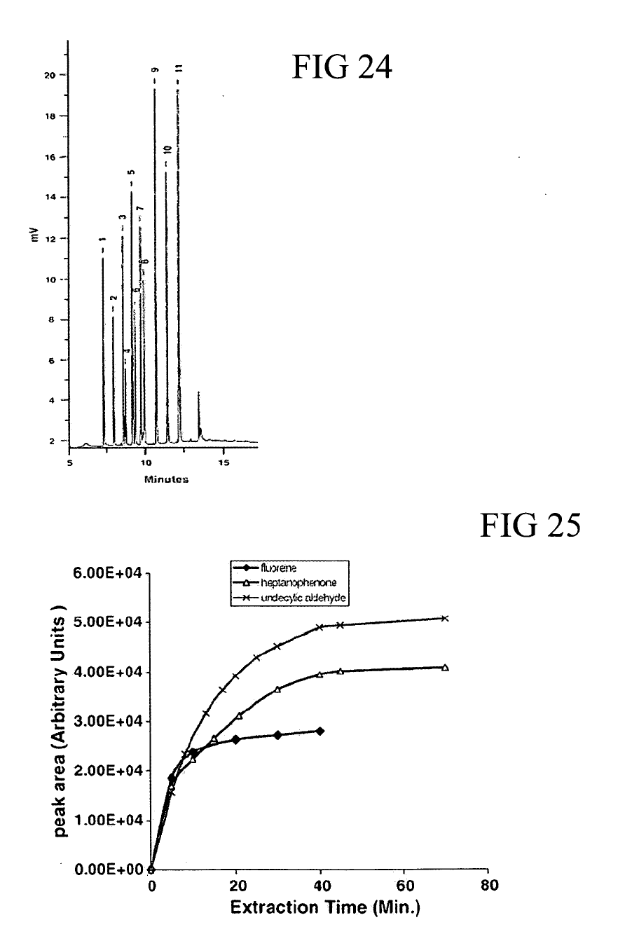

FIG. 24 shows a gas chromatogram illustrating CME-GC analysis of an aqueous sample containing different classes of compounds including PAHs, aldehydes and ketones and demonstrates that the sol-gel zirconia-PDMDPS extraction capillary can provide simultaneous extraction of polar and non-polar compounds present in the aqueous sample and the advantage over conventional SPME coatings that often do not allow such effective extraction of both polar and nonpolar analyte from the same sample.

In capillary microextraction technique, the amount of analyte extracted into the sorbent coating depends not only on the polarity and thickness of the coated phase, but also on the extraction time. FIG. 25 illustrates the kinetic profile for the extraction of fluorene (a non-polar analyte), heptanophenone and undecylic aldehyde (both are moderately polar analytes) on a sol-gel zirconia-PDMDPS-coated microextraction capillary. The CME experiments were carried out using aqueous samples of individual test analytes. The extraction equilibrium for fluorene was reached in 10 min, which is much shorter than extraction equilibrium time for heptanophenone and undecylic aldehyde (both approximately 30 min). This is because fluorene exhibits hydrophobic behavior that has higher affinity toward the non-polar PDMDPS-based sol-gel zirconia coating than toward water. On the other hand, heptanophenone and undecylic aldehyde, being more polar and hydrophilic than fluorene showed a slower extraction by the coated non-polar sol-gel zirconia-PDMDPS sorbent.

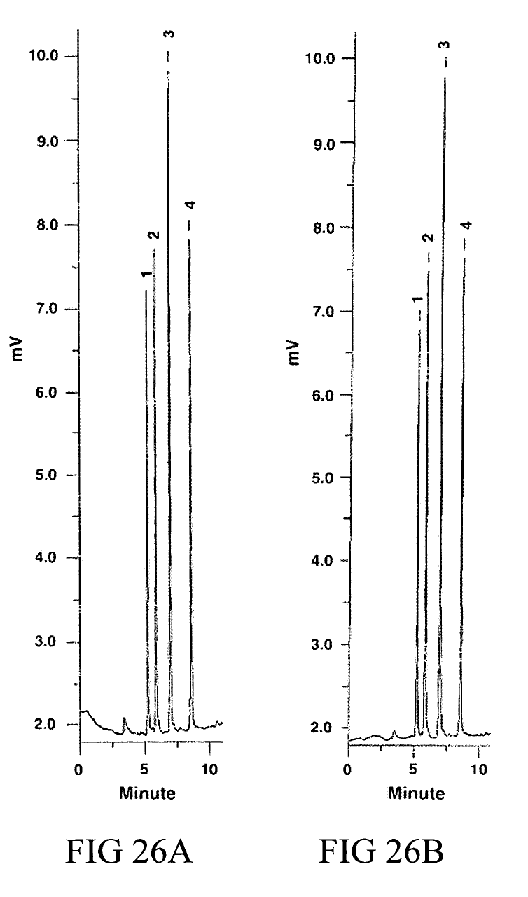

Sol-gel zirconia-PDMDPS coatings showed high pH stability and retained excellent performance after rinsing with 0.1M NaOH (pH 13) for 24 h. Chromatograms in FIGS. 26A and 26B show CME-GC analysis of four PAHs before (FIG. 26A) and after (FIG. 26B) zirconia-PDMDPS extraction capillary was rinsed with 0.1M NaOH solution.

As is evident from FIGS. 26A and 26B, the extraction performance of the sol-gel zirconia-PDMDPS capillary remained practically unchanged after rinsing with NaOH as can be seen in Table VI.

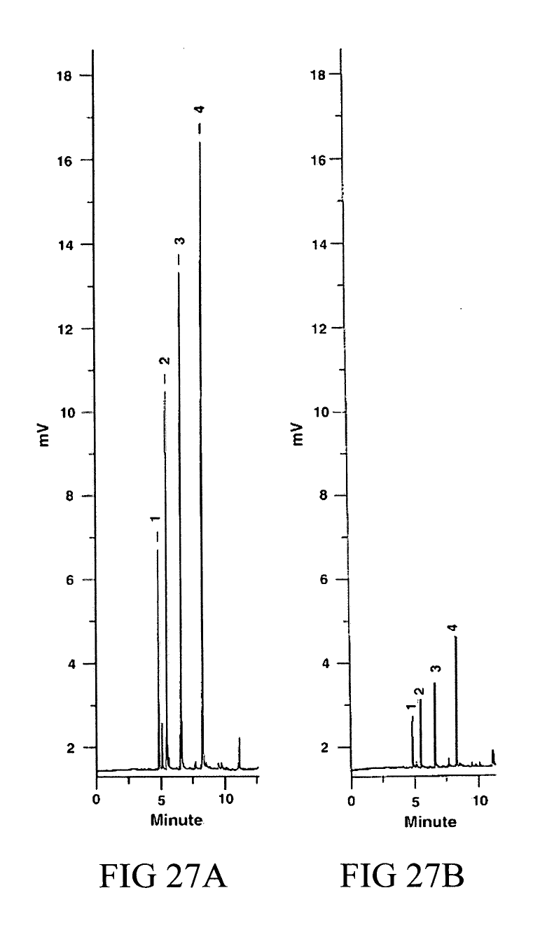

For comparison, the same experiment was conducted using a 10 cm piece of a conventionally coated commercial PDMDPS-based GC column as the microextraction capillary. The results are shown in FIG. 27. A drastic loss in extraction sensitivity after rinsing the conventionally coated silica-based microextraction capillary with 0.1M NaOH solution is obvious (FIG. 27).

These data suggest that the created hybrid sol-gel zirconia-based coatings have significant pH stability advantage over conventional silica-based coatings, and that such coatings have the potential to extend the applicability of capillary microextraction and related techniques to highly basic samples, or analytes that require highly basic condition for the extraction and/or analysis.

### CONCLUSION

Sol-gel zirconia-based hybrid organic-inorganic sorbent coating was developed for use in microextraction. Principles of sol-gel chemistry was employed to chemically bind a hydroxy-terminated silicone polymer (polydimethyldiphenylsiloxane) to a sol-gel zirconia network in the course of its evolution from highly reactive alkoxide precursor (zirconium tetrabutoxide) undergoing controlled hydrolytic polycondensation reactions. For the first time, sol-gel zirconia-PDMDPS coating was employed in capillary microextraction. The newly developed sol-gel zirconia-PDMDPS coating demonstrated exceptional pH stability: its extraction characteristics remained practically unchanged after rinsing with a 0.1M solution of NaOH (pH 13) for 24 h. Solventless extraction of analytes was carried out simply by passing the aqueous sample through the sol-gel extraction capillary for approximately 30 min. The extracted analytes were efficiently transferred to a GC column via thermal desorption, and the desorbed analytes were separated by temperature programmed GC. Efficient CME-GC analyses of diverse range of solutes was achieved using sol-gel zirconia-PDMDPS capillaries. Parts per trillion (ppt) level detection limits were achieved for polar and non-polar analytes in CME-GC-FID experiments. Sol-gel zirconia-PDMDPS coated microextraction capillaries showed remarkable run-to-run repeatability (R.S.D.<0.27%) and produced peak area R.S.D. values in the range of 1.24-7.25%.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

TABLE I
Peak area and retention time repeatability data for ppb and sub-ppb level
concentrations of PAHs, aldehydes, and ketones obtained in five replicate
measurements by Capillary Microextraction-GC using sol-gel PDMS coatings.*

| | | Peak area repeatability | | t_{R} repeatability | | Detection |
|---|---|---|---|---|---|---|
| | | (n = 5) | | (n = 5) | | limits** |
| Chemical Class | | Mean peak area | RSD | Mean | RSD | S/N = 3 |
| of the Analyte | Name of the Analyte | (arbitrary unit) | (%) | t_{R} (min) | (%) | (ppt) |
| PAHs | Naphthalene | 253244.2 | 2.7 | 16.176 | 0.221 | 0.31 |
| | Acenaphthalene 80% | 73188.9 | 2.5 | 19.716 | 0.169 | 0.66 |
| | Acenaphthene 20% | 19563.4 | 2.9 | 20.112 | 0.181 | 0.58 |
| | Fluorene | 132925.8 | 3.3 | 21.271 | 0.205 | 0.44 |
| | Phenanthrene | 58212.3 | 3.6 | 23.376 | 0.148 | 0.94 |
| | Fluoranthene | 128409.4 | 4.0 | 26.029 | 0.167 | 0.39 |
| Aldehydes | Benzaldehyde | 31013.5 | 6.0 | 16.757 | 1..901 | 103.20 |
| | Nonylaldehyde | 174309.0 | 4.9 | 17.770 | 0.304 | 40.45 |
| | o-tolualdehyde | 64092.1 | 5.3 | 18.860 | 0.309 | 92.35 |
| | n-decylaldehyde | 258555.7 | 4.7 | 19.830 | 0.256 | 28.36 |
| | n-Undecylic aldehyde | 229624.5 | 5.7 | 22.492 | 0.337 | 50.49 |
| Ketones | Valerophenone | 31364.9 | 4.8 | 19.146 | 0.094 | 215.70 |
| | Hexanophenone | 65197.5 | 4.3 | 20.424 | 0.077 | 109.10 |
| | Heptanophenone | 71735.6 | 4.5 | 21.653 | 0.066 | 102.60 |
| | 4′-phenylacetophenone | 43686.8 | 5.6 | 24.189 | 0.035 | 117.20 |
| | Decanophenone | 166995.0 | 4.2 | 24.851 | 0.176 | 55.99 |
| | Anthraquinone | 151529.9 | 3.6 | 25.539 | 0.133 | 32.67 |

*Experimental conditions for capillary microextraction and GC analysis are same as in FIGS. 12 (PAHs), 13 (Aldehydes), and 14 (Ketones).
**Detection limits were calculated for a signal-to-noise ratio (S/N) of 3 using the data presented in FIGS. 12 (PAHs), 13 (Aldehydes), and 14 (Ketones).

TABLE II
Peak area and retention time repeatability data for ppb level concentrations
of phenols, alcohols, and amines obtained in five replicate measurements
by Capillary Microextraction-GS using sol-gel PEG coatings. *

| | | Peak area repeatability | | t_{R} repeatability | | Detection |
|---|---|---|---|---|---|---|
| | | (n = 5) | | (n = 5) | | limits** |
| Chemical Class | | Mean peak area | RSD | Mean | RSD | S/N = 3 |
| of the Analyte | Name of the Analyte | (arbitrary unit) | (%) | t_{R} (min) | (%) | (ppt) |
| Phenols | 2,6-dimethylphenol | 39390.7 | 1.6 | 19.445 | 0.071 | 16.06 |
| | 2,5-dimethylphenol | 86727.4 | 1.5 | 20.016 | 0.097 | 7.085 |
| | 2,3-dimethylphenol | 110890.4 | 1.9 | 20.505 | 0.110 | 6.001 |
| | 3,4-dimethylphenol | 70055.3 | 2.0 | 20.717 | 0.115 | 9.421 |
| Alcohols & | Dicyclohexylamine | 137786.0 | 3.9 | 14.402 | 0.171 | 4.088 |
| Amines | Myristyl (C₁₄) alcohol | 135076.9 | 4.2 | 16.524 | 0.152 | 1.992 |
| | Acridine | 138103.6 | 3.8 | 17.728 | 0.153 | 2.318 |
| | Cetyl (C₁₆) alcohol | 152309.7 | 4.1 | 18.074 | 0.142 | 2.009 |
| | Benzanilide | 46488.7 | 4.0 | 18.768 | 0.161 | 5.976 |
| | Stearyl (C₁₈) alcohol | 94410.0 | 4.0 | 19.483 | 0.147 | 3.417 |
| | Arachidyl (C₂₀) alcohol | 107336.0 | 4.0 | 21.070 | 0.135 | 4.182 |

* Experimental conditions for capillary microextraction and GC analysis are same as in FIGS. 16 (Phenols), 17 (Alcohols and Amines).
**Detection limits were calculated for a signal-to-noise ratio (S/N) of 3 using the data presented in FIGS. 16 (Phenols), 17 (Alcohols and Amines).

TABLE III
Names, and chemical structure of the coating solution ingredients
for experimentation series 3 sol-gel capillary.

| Ingredient | Function |
|---|---|
| Zirconium(IV) butoxide | Sol-gel precursor |
| Silanol-terminated poly | Sol-gel-active organic component |
| (dimethyldiphenylsiloxane) | |
| Methylene chloride | Solvent |
| Acetic acid | Chelating reagent |
| Poly(methylhydrosiloxane) | Deactivating reagent |
| 1,1,1,3,3,3- | Deactivating reagent |
| Hexamethyldisilazane | |

TABLE IV
Peak area and retention time repeatability data for PAHs, aldehydes, and
ketones extracted from aqueous samples using four replicate measurements
by CME-GC using sol-gel zirconia-PDMDPS in experimentation series 3.

| | | Peak area repeatability | | t_{R} Repeatability | | |
|---|---|---|---|---|---|---|
| | | (n = 4) | | (n = 4) | | Detection |
| Analyte | | Mean peak area | R.S.D. | Mean | R.S.D. | limit |
| Chemical class | Name | (aribitary unit) | (%) | t_{R} (min) | (%) | (ng/mL) |
| PAHs | Naphthalene | 11692.42 | 7.25 | 15.32 | 0.11 | 0.57 |
| | Acenaphthene | 23560.38 | 4.58 | 17.12 | 0.05 | 0.16 |
| | Fluorene | 30970.30 | 2.45 | 17.73 | 0.12 | 0.09 |
| | Phenanthrene | 09010.92 | 3.46 | 18.76 | 0.10 | 0.06 |
| | Pyrene | 55005.40 | 2.78 | 20.22 | 0.22 | 0.03 |
| | Naphthacene | 22378.12 | 5.42 | 21.44 | 0.14 | 0.05 |
| Aldehyde | 1-Nonanal | 15910.25 | 1.29 | 15.27 | 0.03 | 0.33 |
| | 1-Decanal | 22908.98 | 5.45 | 15.94 | 0.16 | 0.08 |
| | Undecanal | 30413.15 | 5.08 | 16.61 | 0.10 | 0.10 |
| | Dodecanal | 32182.70 | 3.72 | 17.22 | 0.11 | 0.05 |
| Ketones | Valerophenone | 03712.88 | 3.10 | 16.79 | 0.06 | 0.92 |
| | Hexanophenone | 13780.88 | 1.24 | 17.40 | 0.07 | 0.33 |
| | Heptanophenone | 47398.87 | 1.24 | 18.19 | 0.27 | 0.08 |
| | Decanophenone | 83156.67 | 2.20 | 19.44 | 0.11 | 0.02 |
| | Trans-chalcone | 06546.25 | 5.57 | 19.82 | 0.03 | 0.57 |

TABLE V
Capillary-to-capillary and run-to-run peak area repeatability
for mixture of PAHs, aldehydes, and ketones in four
replicate measurements by CME-GC using sol-gel zirconia-PDMDPS
coated extraction capillaries

| | Peak area repeatability (n = 4) | | | |
|---|---|---|---|---|
| | Capillary-to-capillary | | Run-to-run | |
| Name of the | Mean peak area | R.S.D. | Mean peak area | R.S.D. |
| analyte | (aribitary unit) | (%) | (aribitary unit) | (%) |
| Undecanal | 47940.9 | 4.60 | 60364.2 | 4.03 |
| Hexanophenone | 27538.4 | 1.61 | 25055.5 | 2.13 |
| Fluorene | 53250.7 | 5.40 | 59485.7 | 2.14 |
| Phenanthrene | 51399.9 | 4.91 | 54867.9 | 2.84 |

TABLE VI
Peak area repeatability data for ppb level concentrations
of PAHs before and after extraction capillary treated
with 0.1 M NaOH from experimentation series 3.

| | Peak area | Peak area | |
|---|---|---|---|
| | repeatability | repeatability | |
| | before rinsing | after rinsing | |
| | with 0.1 M | with 0.1 M | Relative change |
| | NaOH Mean peak | NaOH Mean peak | in peak area |
| Name of the | area A1 | area A2 | \|(A2 − A1)/ |
| analyte | (aribitary unit) | (aribitary unit) | A1\| × 100 (%) |
| Acenaphthene | 30380.91 | 29432.76 | 3.12 |
| Fluorene | 35425.63 | 33428.86 | 5.64 |
| Phenanthrene | 47547.31 | 46525.33 | 2.15 |
| Pyrene | 33884.61 | 35636.56 | 5.17 |

### REFERENCES

Abe, I.; Kameyama, K.; Wasa, T.; Chromatographia 27, 631-633 (1989).
Aichholz, R. J. High Resolut. Chomatogr. 1990, 13, 71-73.
Alltech Chromatography Catalog, 1997, p. 172.
Altgelt, K. H.; Gouw, T. H., Chromatography in Petroleum Analysis, Marcel Dekker, New York, 1979.
An, M.; Haig, T.; Hatfield, P. J. Chromatogr. A 2001, 917, 245-250.
Arkles, B.; Steinmetz, J. R.; Zazyczny, J.; and Mehta, P. in Silicon Compounds: Register and Review, Huls, 1991, pp. 65-73.
Arthur, C. L.; Killam, L. M.; Buchcholz, K. D.; Pawliszyn, J.; Berg, J. Anal. Chem. 1992, 64, 1960-66.
Arthur, C. L.; Killam, L. M.; Motlagh, S.; Potter, D. W.; Pawliszyn J. Environ. Sci. Technol. 1992, 26, 979-83
Arthur, C. L.; Pawliszyn, J. Anal. Chem. 1990, 62, 2145-2148.
Arthur, C. L.; Potter, D. W.; Buchholz, K. D.; Pawliszyn, J. LC. GC. 1994, 10, 656-61 Atik, M.; Luna, F. P.; Messaddeq, S. H.; Aegerter, M. A. J. Sol. gel. Sci. Technol. 1997, 8, 517-522.
Augusto, F.; Koziel, J.; Pawliszyn, J. Anal. Chem. 2001, 73, 481-486.
Aylott, J. W.; Richardson, D. J.; Russell, D. A. Chem. Mater. 1997, 9, 2261-2263.
Ballesteros, E.; Cardenas, S.; Gallego, M.; Valcarcel, M. Anal Chem. 1994, 66, 628-634.
Bartle, K. D.; Woolley, C. L.; Markides, K. E.; Lee, M. L.; Hanse, R. S. J. High Resolut Chromatogr./Chromatogr. Commun 1987, 10, 128-136.
Belardi, R. P.; Pawliszyn, J. Water Pollut. Res. J. Canada 1989, 24, 179-191.
Berezkin, V. G., Drugov, I. S., Gas Chromatography in Air Pollution Analysis, Elsevier, Amsterdam, 1991.
Berezkin, V. G.; Gavrichev, V. S.; Malik, A. J. Liq. Chromatogr. 1987, 10, 1707-1726.
Berezkin, V. G.; Shiryaeva, V. E.; Popova, T. P. Zh. Analit. Khim. 1992, 47, 825-831.
Berladi, R. P.; Pawliszyn, J. Water Pollut. Res. J. Can. 1989, 24, 179-91.
Berladi, R. P.; Pawliszyn, J. Water Pollut. Res. J. Can. 1989, 24, 179-91.
Biau, K.; King, G., Eds. Handbook of Derivatives for Chromatography, 2nd ed.; Heyden: London, 1993.
Bigham, S.; Kabir, A. et al. Anal Chem. 2002, 74, 752.
Blomberg, L.: Markides, K. E.; Wamman, T. J. High Resolut. Chromatogr. Chromatogr. Commun. 1980, 3, 527.
Blomberg, L. G. J. Microcol. September 1990, 2, 62-68.
Blomberg, L; Wannman, T. J. Chromatogr. 1978, 148, 379-387.
Blum, W. J. High Resolut. Chromatogr./Chromatogr. Commun. 1986, 9, 350-355.
Bouche, J.; Verzele, M. J. Gas Chromatogr. 1968, 6, 501-505.
Bradley, D. C.; Mehrotra, R. C.; Gaur, D. P. Metal Alkoxide, Academic Press, London, 1978, p. 162.
Brinker, C. J.; Scherer, G. W. Sol-Gel Science, Academic Press, San Diego, Calif., 1990.
Brown, P. R.; Beebe, J. M.; Turcotte, Jr. Crit, Rev. Anal. Chem. 1989, 21, 193-208.
Buchholz, K. D.; Pawlyszyn, J. Anal. Chem. 1994, 66, 160-167.
Buldt, A.; Kurst, U. Anal. Chem. 1999, 71, 1893-1898.
Cabrera, K.; Lubda, D.; Eggenweiler, H.-M.; Minakuchi, H.; Nakanishi, K. J. High Resol. Chromatogr. 2000, 23, 93-99.
Cancho, B.; Ventura, F.; Galceran, M. T. J. Chromatogr. A 2002, 943, 1.
Chang, C.-H.; Gopalan, R.; Lin, Y. S. J. Membr. Sci. 1994, 91, 27.
Chaput, F.; Dunn, B.; Fuqua, P.; Salloux, K. J. Non. Cryst. Solids. 1995, 188, 11-18.
Chen, Z.; Hobo, T. Anal. Chem. 2001, 73, 3348-3357.
Chong, S. L.; Wang, D.-X.; Hayes, J. D.; Wilhite, B. W.; Malik, A. Anal. Chem. 1997, 69, 3889-3898.
Clement, R. E. (ed.), Gas chromatography: Biochemical, Biomedical, and Clinical Applicants, Wiley, New York, 1990.
Collinson, M. M Howells, A. R. Anal. Chem. 2000, 72, 702A-709A.
Cortes, H. J.; Pfeiffer, C. D.; Richter, B. E.; Stevens, T. S. J. High. Resolut. Chromatogr./Chromatogr. Commun. 1987, 10, 446-448.
Coulibaly, K; Jeon L. J. Food Rev. Int. 1996, 12, 131-151.
Dang, Z.; Anderson, B. G., Amenomiya, Y.; Morrow, B. A. J. Phys. Chem. 1995, 99, 14437.
de Fatima Alpendurada, M. J. Chromatogr. A 2000, 889, 3-14.
de Jong, C.; Badings, H. J. High Resolut. Chromatogr. 1990, 13, 94-98.
de Nijs; R. C. M.; Franken, J. J.; Dooper, R. P. M.; Rijks, J. A.; de Ruwe, J. J. J. M.; Schulting, F. L. J. Chromatogr. 1978, 167, 231-242.
Dire, S.; Campostrini, R.; Ceccato, R. Chem. Mater., 1998, 10, 268.
Dislich, H. in Sol-gel Technology for This Films, Fibers, Performs, Electronics, and Specialty Shapes, (L. C. Klein ed., Noyes Publications, Park Ridge, N.J., USA, 1988), pp. 50-79.
Doesey, J. G.; Lister, A. S.; Wright, P. B.; Wendelken, S. C.; Chester, T. L. Proc. 19th International Symposium on Capillary Chromatography and Electrophoresis, Wintergree, Va., USA, May 18-22, 1997, pp. 62-63.
Dulay, M. T.; Kulkarni, R. P.; Zare, R. N. Anal. Chem. 1998, 70, 5103-5107.
Dutoit, D. C.; Schneider, M.; Baiker, A. J. Catal. 1995, 153, 165-176.
Eisert, P.; Pawliszyn, J. Anal. Chem. 1997, 69, 3140-3147.
Engelhardt, H.; Cunat-Walter, M. A. J. Chromatogr. 1995, 716, 27-33.
EPA Method 604. Phenols in Federal Register, Environmental Protection Agency: Friday, Oct. 6, 1984; pp. 58-66.
Ettre, L. C. Chromatographia 1948, 18, 477-488.
Ettre, L. S., Hinshaw, J. V. Basic Relationship in Gas Chromatography, Advanstar, Cleveland, USA, 1994, p. 144.
Fabes, B. D.; Uhlmann D. R. J. Am. Ceram. Soc. 1990, 73, 978-988.
Fadeev, A. Y.; Helmy, R.; Marcinko, S. Langmuir 2002, 18, 7521.
Ferioli, F.; Vezzalini, F.; Rustichelli, C.; Gamberini, G. Chromatographia 1995, 41, 61-65.
Fielding, M.; Farrimond, M. Disinfection By-Products in Drinking Water. Current Issues, Royal Society of Chemistry, Cambridge, UK, 1999.
Fields, S. M. Anal. Chem. 1996, 68, 2709-2712.
Fujimoto, C. J. High Resol. Chromatogr. 2000, 23, 89-92.
Ganguli and Kundu (J. Mater. Sci. Lett. 1984, 3, 503.
Gbatu, T. P.; Sutton, K. L.; Caruso, J. A. Anal. Chim. Acta 1999, 402, 67-79.
Golay, M. J. E., in Coates, V. J.; Noebels, H. J.; Faberson I. S. (eds.), Gas Chromatography (1957 Lansing Symposium), Academic Press, New York, 1958, pp. 1-013.
Golubko, N. V.; Yanovskaya, M. I.; Romm, I. P.; Ozerin, A. N. J. Sol-Gel Sci. Technol 2001, 20, 245.
Gou Y.; Pawliszyn, J. Anal. Chem. 2000, 72, 2774-2779.
Gou, Y.; Eisert, R.; Pawliszyn, J. J. Chromatogr. A 2000, 873, 137-147. Gou, Y.; Tragas, C.; Lord, H.; Pawliszyn, J. J. Micro September 2000, 12, 125-134. Grob, K. Jr.; Grob, G.; Grob, K.; 1978: 156, 1-20.
Grob, K.; Grob, G.; Blum, W.; Waither, W. J. Chromatogr. 1982, 244, 197-204.
Guermeur, C.; Lambard, J.; Gerard, J.-F.; Sanchez, C. J. Mater. Chem. 1999, 9, 769.
Guidelines for Drinking Water Quality, 2nd ed. WHO (World Health Organization): Geneva, 1993.
Guizard, C.; Cygankiewicz, N.; Larbot, A.; Cot, L. J. Non-Cryst. Solids 1986, 82, 86.
Guo, Y.; Colon, L. A. Anal. Chem. 1995, 67, 2511-2516.
Guo, Y.; Colon, L. A. Chromatographia 1996, 43, 477-483.
Guo, Y.; Colon, L. A. J. Microcol. September 1995, 7, 485-491.
Guo, Y.; Imahori, G. A.; Colon, L. A. J. Chromatogr. A. 1996, 744, 17-29.
Hamlet, C.; Shende, C.; Kabir, A.; Malik, A. Work in progress.
Hartmann, H.; Burhenne, J.; Spiteller, M. Fres. Environ. Bull. 1998, 7, 96-103.
Haruvy, Y.; Gilath, I.; Maniewictz, M.; Eisenberg, N. Chem. Mater. 1997, 9, 2604-2615.
Hawthorne, S. B.; Anal. Chem. 1990, 62, 633A-642A.
Hayes, J. D.; Malik, A. HPCE '97—Final Program (Jan. 26-30, 1997, Anaheim, Calif., USA), pp. 80-81.
Hayes, J. D. “Sol-Gel Chemistry-Mediated Novel Approach to Column Technology for Electromigration Separations,” Ph.D. dissertation, Department of Chemistry, University of South Florida, Tampa, Fla., USA, 2000.
Hayes, J. D.; Malik, A. Anal. Chem. 2000, 72, 4090-4099.
Hayes, J. D.; Malik, A. Anal. Chem. 2001, 73, 987-996.
Hayes, J. D.; Malik, A. J. Chromatogr. B, 1997, 695, 3-13.
Hirata, Y.; Pawliszyn, J. J. Microcolumn September 1994, 6, 443-447.
Iler, R. K. The Chemistry of Silica, Wiley, New York, 1979.
In, M.; Gerardin, C.; Lambard, J.; Sanchez, C. J. Sol. gel. Sci. Technol. 1995, 5, 101-114.
Iwamoto, T.; Mackenzie, J. D. J. Sol-gel Sci. Technol. 1995, 4, 141-150.
Janak, K.; Horka, M.; Krejci, M. J. Microcol. September 1991, 3, 115-120.
Janak, K.; Kahie, V.; Tesarik, K.; Horka, M. J. High Resolut. Chromatogr./Chromatogr. Commun. 1985, 8, 843-847.
Jiang, Z.-; Zuo, Y.-Anal. Chem. 2001, 73, 686-688.
Jinno, K.; Muramatsu, T.; Saito, Y.; Kiso, Y.; Magdic, S.; Pawliszyn J. J. Chromatogr. A. 1996, 754, 137-144.
Jones, S. A.; Wong, S.; Burlitch, J. M.; Viswanathan, S.; Kohlstedt, D. L. Chem. Mater. 1997, 9, 2567-2576.
Kandu, D; Biswas, P. K.; Ganguli, D. Thin Solid Films, 1988, 163, 273.
Kataoka, H.; Lord, H. L.; Pawliszyn, J. J. Anal. Toxicol. 2000, 24, 257-265.
Kataoka, H.; Lord, H. L.; Pawliszyn, J. J. Chromatogr. B 1999, 731, 353-359.
Kataoka, H.; Narimatsu, S.; Lord, H.; Pawliszyn, J. Anal. Chem. 1999, 71, 4237-4244.
Kataoka, H.; Pawliszyn, J. Chromatographia 1999, 50, 532-538.
Kim, T. Y.; Alhooshani, K.; Kabir, A.; Fries, D. P.; Malik, A. J. Chromatogr. A. 2004, 1047, 165.
Klein, L. C. Sol-gel Technology for Thin Films, Fibers, Pre forms, Electronics, and Specialty Shapes; Noyes Publications: Park Ridge, N.J., USA, 1988
Koivusalmi, E.; Haatainen, E.; Root, A. Anal. Chem. 1999, 71, 86-91.
Koster, E. H.; Bruins, C. H.; Wemes, C.; de Jong, G. J. J. Sep. Sci. 2001, 24, 116-122.
Kosuge, K.; Singh, P. S. J. Phys. Chem. B 1999, 103, 3562-3569.
Koziel, J. A.; Noah, J.; Pawliszyn, J. Environ. Sci. Technol. 2001, 35, 1481-1486.
Larbot, A.; Alary, J. A.; Guizard, C.; Cot, L.; Gillot, J. J. Non-Cryst. Solids 1988, 104, 161.
Lawrocki, J. Chromatographia 1991, 31, 177-205
Lee, M. L.; Kohn, R. C.; Woolley, C. L.; Bradshaw, J. S. J. Chromatogr, Sci. 1984, 22, 136-142.
Lee, M. L; Yang, F. J.; Bartle, K. D. Open Tubular Column Gas Chromatography: Theory and Practice, Wiley, New York, 1984.
Lev, O.; Bharathi, S.; Glezer, V.; Modestov, A.; Gun, J.; Rabinovich, L.; Sampath, S. Chem. Mater. 1997, 9, 2354-2375.
Li, D.; Park, J.; Oh, J.-R. Anal. Chem. 2001, 73, 3089-3095.
Liu, Y.; Shen, Y.; Lee, M. L. Anal. Chem. 1997, 69, 190-195.
Livage, J. In Applications of Organometallic Chemistry in the Preparation and 5 Processing of Advanced Materials, Harrod, J. F., Lame, R. M. Eds.; Kluwer: Dordrecht, The Netherlands, 1995; pp. 3-25.
Livage, J.; Henry, M.; Sanchez, C. Prpg. Solid. St. Chem. 1988, 18,259-341.
Lobnik, A.; Wolfbeis, O. S. Sens. Actuators B 1998, 51, 203-207.
Lopez-Avila, V.; Bauer, K.; Milanes, J.; Beckert W. F. J. AQAC Int. 1993, 76, 864 880.
Louch, D.; Motlagh, S.; Pawliszyn J.; Anal. Chem. 1992, 64, 1187-1199.
Mackenzie, J. D. in Hybrid Organic-Inorganic Composites (ACS Symposium Series 585, American Chemical Society, Washington, D.C., 1995), pp. 227-236.
Majors, R. E. LC*GC. Int. 1997, 10, 93-101.
Malik, A.; Chong, S. L. In Applications of Solid-phase Microextraction, Pawliszyn, J. Ed.; Royal Society of Chemistry (RSC): Cambridge (UK), 1999; pp. 73-91.
Malik, A.; Hayes, J. D.; Wang, D. X.; Chong, S. L.; Corbett, G. S.; Cramer, J. W.; 25 Proc. 19th International Symposium on Capillary Chromatography and Elctrophoresis, Wintergreen, Va., USA, May 18-22, 1997, pp. 54-55. Martos, P. A.; Pawliszyn, J. Anal. Chem. 1998, 70,2311-2320.
Marcinko, S.; Helmy, R.; Fadeev, A. Y. Langmuir 2003, 19, 2752.
McComb, M. E.; Oleschuk, R. D.; Giller, E.; Gesser, H. D. Talanta 1997, 44, 2137-2143.
Medlar, J.; Kabir, A.; Malik, A. Work in Progress.
Mehrotra, R. C. J. Non-Cryst. Solids 1990,121, 1-6. Merck Index, 12th Edition, 1996, p. 9812.
Minnich, M.; Zimmerman, J. H.; Schumacher, B. A., J. AQAC Int. 1996, 1198-1204.
Mori, T.; Yamamura, H.; Kobayashi, H.; Mitamura, T. J. Am. Ceram. Soc. 1992, 75, 2420.
Mukherjee S., “Supercritical drying in structural and microstructural evaluation of gels: A critical review,” in Ultrasound Processing of Advanced Ceramics (Mackenzie, J. D. and Ulrich, D. R., eds., Wiley, New York, 1988), pp. 747-759 Muller, L.; Gorecki, T.; Pawliszyn, J. Fres. J. Anal. Chem. 1999, 364, 610-616.
Nakanishi, K.; Minakuchi, H.; Soga, N.; Tanaka, N. J. Sol. gel. Sci. Technol. 1997, 8, 547-552.
Narang, P.; Colon, L. A. J. Chromatogr. A. 1997, 773, 65-72.
Nawrocki, J. J. Chromatogr. A 1996, 749, 157-163.
Noonan, G. O.; Ledford, J. S. Chem. Mater 1995, 7, 1117.
Novak, B. M. Adv. Mater. 1993, 5, 422-433.
Oesterheldt, G.; Pozeg, M.; Bubendort, A.; Bartoldus, D. Fres. Z Anal. Chem. 1985, 321, 553-555.
Okubo, T.; Takahashi, T; Sadakata, M.; Nagamoto, H. J. Membr. Sci. 1996, 118, 151.
Palkar, V. R. Nanostructured Mater. 1999, 11, 369-374.
Papet, P.; Le Bars, N.; Baumard, J. F.; Lecomte, A.; Dauger, A. J. Mater. Sci. 1989, 24, 3850.
Percy, M. J., Barlett, J. R., Spiccia, L., West, B. O., Woolfrey, J. L. J. Sol-Gel Sci. Technol. 2000, 19, 315.
Peshev, P.; Slavova, V. Mater. Res. Bull. 1992, 27, 1269.
Paterson, M. J. McCulloch, D. G.; Paterson, P. J. K.; Ben-Nissan, B. Thin Solid Film, 1997, 311, 196.
Pawliszyn, J. Solid Phase Microextraction. Theory and Practice, Wiley: NY, 1997.
Pawliszyn, J. J. Chromatogr. Sci. 2000, 37, 270-270.
Poole, C. F.; Poole, S. K., in E. Heftman (ed.) Chromatography, 5th Edition, Part A: Fundamentals and Techniques (J. Chromatogr. Libr. Vol. 51A, Amsterdam, 1992), ch. 9
Poole, S. K; Dean, T. A.: Oudsema J. W.; and Poole, C. F.; Anal. Chim. Acta. 1990, 236, 3-42.
Potter, D. W.; Pawliszyn, J. Environ. Sci. Technol. 1994, 28, 298-305.
Potter, D. W.; Pawliszyn, J. J. Chromatogr. 1992, 625, 247-55.
Prakash, S. S.; Brinker C. J.; Hurd, A. J.; Rao, S. M. Nature 1995, 374-439-443.
Puccetti, G.; Leblanc, R. M. J. Phys. Chem. B 1998, 102, 9002.
Pursch, M.; Jager, A.; Schneller, T.; Brindle, R.; Albert, K.; Lindner, E. Chem. Mater. 1996, 8, 1245-1249.
Rabinovich, E. M. In Sol Gel Technology for Thin Films, fibers, Pre forms, Electronics, and Specialty Shapes, Klein, L. C. Ed.; Noyes Publications: Park Ridge, N.J., 1988; pp. 260-294.
Ramsey, J. D. F., “Sol-gel Processing” in Controlled Particle, Droplet and Bubble Formation, (D. J. Wedlock ed., Butterworth, U.K, 1994), pp. 1-37
Reighard, T. S.; Olesik, S. V.; Crit. Rev. Anal. Chem. 1996, 26, 61-99.
Reisfeld, R.; Jorgenson, C. K. (eds.), Spectroscopy, Chemistry, and Applications of Sol-gel Glasses, Springer-Verlag, Berlin, 1992.
Reynolds, K. J.; Colon, L. A. J. Liq. Chromatogr. & Rel. Technol. 2000, 23, 161-173.
Richter, B. E.; Jones, B. A.; Ezzel, J. L.; Porter N. L.; Abdalovic N.; Pohi, C. Anal. Chem. 1996, 1033-1039.
Richter, B. E.; Kuci, J. C.; Park, N. J.; Crowley, S. J.; Bradshaw, J. S.; Lee, M. L. J. High Resolut. Chromatogr./Chromatogr. Commun. 1986, 6, 371-373.
Rodriguez, I.; Liompart, M. P.; Cela, R. J. Chromatogr. A 2000, 885, 291-304.
Rodriguez, S. A.; Colon, L. A. Anal. Chim. Acta 1999, 397, 207-215.
Rodriguez, S. A.; Colon, L. A. Chem. Mater. 1999, 11, 754-762.
Roed, L.; Lundanes, E.; Greibrokk, J. Chromatogr. A 2000, 890, 347-353.
Roed, L.; Lundanes, E.; Greibrokk, T. J. Micro September 2000, 12, 561-567.
Rotzsche, H. Stationary Phases in Gas Chromatography, Elsevier Scientific Publishing Company: Amsterdam, The Netherlands, 1991.
Sakka, S.; Yoko, T. In Chemistry, Spectroscopy, and Applications, Reisfeld, R., Jorgenson, C. K. Eds.; Springer-Verlag: Berlin, 1992; pp. 89-118.
Sanchez, C.: Ribot, F. New J. Chem. 18, 1007-1047 (1994).
Scheppers Wercinski, S. A. Solid-phase Microextraction: A Practical Guide, Marcel Dekker: NY, 1999.
Scherer, G. W., “Aging and drying of gels,” J. Non-Cryst. Solids 1988, 100, 77-92.
Schomburg, G.; Husmann, H.; Borwitsky, H., Chromatographia 1979, 12, 651-660.
Senevirante, J.; Cox, J. A. Talanta 2000, 52, 801-806.
Severin, K. G.; Ledford, J. S.; Torgerson, B. A.; Berglund, K. A. Chem. Mater., 1994, 6, 890.
Sharp, K. G. J. Sol-gel Sci. Technol. 1994, 2,35-41.
Shende, C.; Kabir, A.; Hamlet, C.; Malik, A. Manuscript in preparation.
Silva, R. B.; Gushikem, Y.; Collins, C. H. J. Sep. Sci. 2001, 24, 49-54.
Sorek, Y.; Reisfeld, R.; Weiss, A. M. Chem. Phys. Lett. 1995, 244, 371.
Stark, F. O., Johnson, O. K.; Vogel, E. G.; Chafee, R. G.; Lacefield, R. M. J. Phys. Chem. 1968, 72, 2750-2754.
Sumpter, S. R.; Woolley, C. L.; Hunag, E. C.; Markides, K. E.; Lee, M. L. J. Chromatogr. 1990, 517, 503-519.
SUPELCO Catalog 2001: Chromatography Products for Analysis and Purification, Aldrich-Sigma Co.: USA, 2001; p. 259.
Supelco Corp., Bellefonte, Pa. Manufacturer data sheet. 1996.
Tang, Q.; Xin, B.; Le, M. L. J. Chromatogr. A 1999, 837, 35-50.
Tebbett, I. (Ed.), Gas Chromatography in Forensic Science, E. Horwood, N.Y., 1991.
Toba, M.; Mizukami, F.; Niwa, S.-I.; Sano, T.; Maeda, K.; Annila, A.; Komppa, V. J. Mol. Catal., 1994, 94, 85.
Thouless, M. D.; Olsson, E.; Gupta, A. Acta Metall. Mater., 1992, 40, 1287.
van Deemter, J. J.; Zuiderweg, F. J.; Klinkenberg, A. Chem. Eng. Sci. 1956, 5, 271-289.
van der Vhs, E.; Mazereeuw, M.; Tjaden, U. R.; Irth, H.; van der Greef, J. J. Chromatogr. A. 1994, 333-341.
Vicanova, J.; Tvrzicka, E.; Stuhik, K. J. Chromatogr. B 1994, 656, 45-50.
Vorotilov, K. A.; Petrovsky, V. I.; VasiUev, V. A.; Sobolevsky, M. V. J. Sol-gel Sci. Technol. 1997, 8, 581-584.
Walsh, D.; Whilton, N. T. Chem. Mater. 1997, 9, 2300-2310.
Wang, D. X. Sol-gel Chemistry-Mediated Novel Approach to Column Technology for High-Resolution Capillary Gas Chromatography, Ph.D. Dissertation, University of South Florida, Department of Chemistry: Tampa, Fla., 2000.
Wang, D.-X.; Chong, S.-L.; Malik, A. Anal. Chem. 1997, 69, 4566-4576.
Wang, D; Malik, A. Proc. 18th Intl. Symp. Cap. Chromatogr. (May 20-24, 1996, Riva del Garda, Italy), P. Sandra & G. Devos (eds.), Huthig Publishers: Germany, 1996, pp. 505-513.
Wang, Z. Y.; Xiao, C. H.; Wu, C. Y.; Wu, C.; Han, H. J. Chromatogr. A 2000, 893, 157-168.
Wang, D.; Chong, S. L.; Malik, A.; Anal Chem. 1997, 69, 4566.
Welxch, T.; Teichmann, U., J. High Resolut. Chromatogr., 1991, 14,153-159.
Westwood, S. A. (Ed.), Supercritical Fluid Extraction and Its Use in Chromatographic Sample, CRC Press, Boca Raton, Fla., USA 1993.
WHO, Air Quality Guidelines for Europe, WHO European, Series No. 23, Copenhagen, Denmark, 1987.
Wilkes, G. L.; Arler, B.; Huang, H. H. Polymer Prep. 1985,26, 300.
Woolley, C. L.; Koihn, R. C.; Richter, B. E.; Lee, M. L. J. High Resolut. Chromatogr./Chromatogr. Commun. 1984, 7, 329-332.
Woolley, C. L.; Markides, K. E.; Lee, M. L. J. Chromatogr. 1986, 367, 9-22.
Woolley, C. L; Markides, K. E.; Lee, M. L.; Bartle, K. D. J. High Resolut. Chromatogr./Chromatogr. Commun. 1986, 9, 506-514.
Wright, B. W.; Peaden, P. A.; Lee, M. L.; Stark, T. J. J. Chromatogr. 1982, 248, 17-34.
Wu, J.; Lord, H. L.; Pawiszyn, J.; Kataoka, H. J. Micro. September 2000, 12, 255-266.
Wu, J.; Mester, Z.; Pawliszyn, J. Anal. Chim. Acta 2000, 424, 211-222.
Wu, J.; Pawliszyn, J. Anal. Chem. 2001, 73, 55-63.
Wu, J.; Pawliszyn, J. J. Chromatogr. A 2001, 909, 37-52.
Wu, N.-L.; Wang, S.-Y.; Rusakova, I. A. Science 1999, 285, 1375.
Wu, J. C.-S.; Cheng, L.-C. J. Membr. Sci. 2000, 167, 253.
Yakabe, Y.; Sudoh, Y.; Takahata, Y. J. Chromatogr. 1991, 558, 323-327.
Zapf, A.; Stan, H. J. J. High Resol. Chromatogr. 1999, 22, 83-88.
Yoldas, B. E. J. Non-Cryst. Solid, 1984, 63, 145.
Zeng, Z.; Qiu, W.; Huang, Z. Anal. Chem. 2001, 73, 2429-2436.
Zhang, J.; Zhang, L.; Ilacqua, V. Environ. Sci. Technol. 2000, 34, 2601-2607.
Zhang, Z.; Yang, M. J.; Pawliszyn, J. Anal. Chem. 1994, 66, 844A-853A.
Zhan, Z.; Zeng, H. C. J. Non-Cryst. Solids, 1999, 243, 26.
Zlotorzynski, A. Crit. Rev. Anal Chem. 1995, 25, 43-76.

I claim:

1. A microextraction device comprising:
a) a hollow capillary, and
b) at least one sol-gel extraction medium within said hollow capillary for trapping at least one target analyte, said sol-gel extraction medium chemically bound to the inner surface of said hollow capillary to form a sol-gel extraction medium-loaded capillary.

2. The microextraction device according to claim 1, wherein said sol-gel extraction medium comprises:
a) a porous sol-gel monolithic bed, said monolithic bed having a thickness equal to an internal diameter of said hollow capillary; or
b) a sol-gel coating.

3. The microextraction device according to claim 1, wherein an organic component of said sol-gel is selected from the group consisting of sol-gel-active forms and/or derivatives of poly(ethylene glycol), poly(methylphenylsiloxane), poly(dimethyldiphenylsiloxane), poly(dimethylsiloxane), and poly(methylcyanopropylsiloxane).

4. The microextraction device according to claim 1, wherein an organic component of said sol-gel is selected from the group consisting of sol-gel-active forms and/or derivatives of octadecylsilane, octylsilane, crown ethers, cyclodextrins, calixarenes, dendrimers, poly(styrene), poly(styrene-divinylbenzene), poly(acrylate), and molecularly imprinted polymers.

5. The microextraction device according to claim 1, wherein said hollow capillary provides an internal diameter of at least 250 μm.

6. The microextraction device according to claim 1, wherein said device provides at least parts per trillion (ppt) level detection sensitivities.

7. The microextraction device according to claim 1, wherein said sol-gel extraction medium comprises 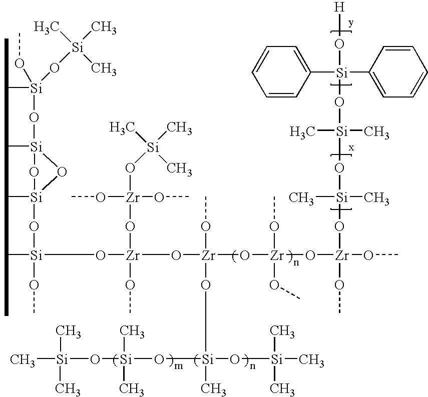
, wherein m=An integer ≧0;
n=An integer ≧0
x=An integer ≧0;
y=An integer ≧0;
and m, n, x, and y are not simultaneously zero.

8. The microextraction device according to claim 1, wherein the capillary is hydrothermally treated.

9. The microextraction device according to claim 1, wherein the sol-gel extraction medium comprises a plurality of zirconia elements.

10. A microextraction device prepared by the method comprising:
a) processing a hollow capillary by hydrothermal treatment, said hollow capillary including an inner surface; and
b) filling the capillary with a sol-gel extraction medium, wherein the sol-gel extraction medium is chemically bound to the inner surface of the hollow capillary to form a sol-gel extraction medium-loaded capillary; or
c) processing a hollow capillary by hydrothermal treatment, said hollow capillary including an inner surface; and
d) filling the capillary with a sol-gel extraction medium, wherein the sol-gel extraction medium is chemically bound to the inner surface of the hollow capillary to form a sol-gel extraction medium-loaded capillary; and
e) preconditioning said sol-gel extraction medium.

11. The device according to claim 10, wherein said preconditioning step comprises heating and purging an inert gas over said sol-gel extraction medium.

12. The device according to claim 10, wherein said sol-gel extraction medium comprises:
a) a porous sol-gel monolithic bed having a thickness equal to an inner diameter of said hollow capillary; or
b) a sol-gel coating.

13. The device according to claim 10, wherein an organic component of said sol-gel is selected from the group consisting of sol-gel active forms and/or derivatives of poly(ethylene glycol), poly(methylphenylsiloxane), poly(dimethyldiphenylsiloxane) poly(dimethylsiloxane), and poly(methylcyanopropylsiloxane).

14. The device according to claim 10, wherein an organic component of said sol-gel is selected from the group consisting of sol-gel active forms and/or derivatives of octadecylsilane, octylsilane, crown ethers, cyclodextrins, calixarenes, dendrimers, poly(styrene), poly(styrene-divinylbenzene), poly(acrylate), and molecularly imprinted polymers.

15. The device according to claim 10, wherein said sol-gel extraction medium comprises a plurality of zirconia elements.

16. The device according to claim 10, wherein said sol-gel extraction medium is prepared from a sol solution comprising a transition metal alkoxide other than a silica alkoxide, a sol-gel organic component, a chelating reagent, and at least one deactivation reagent in a solvent.

17. The device according to claim 16, wherein the transition metal alkoxide is selected from the group consisting of zirconium isopropoxide, zirconium tetrapropoxide, and zirconium (IV) butoxide.

18. The device according to claim 16, wherein the sol-gel organic precursor is selected from the group consisting of polydimethylsiloxane (PDMS), polymethylphenylsiloxane (PMPS), silanol-terminated polydimethyldiphenylsiloxane (PDMDPS), and poly(methylcyanopropylsiloxane).

19. The device according to claim 16, wherein the chelating reagent is selected from the group consisting of acetic acid, valeric acid, β-diketone, triethanolamine, and 1,5-diaminopentane.

20. The device according to claim 16, wherein the at least one deactivating reagent comprises a first deactivation reagent and a second deactivation reagent, wherein the first deactivation reagent is poly(methylhydrosiloxane), and the second deactivation reagent is 1,1,1,3,3,3-hexamethyldisilazane.

21. An apparatus useful for preconcentrating and analyzing target analytes in a sample, wherein said apparatus comprises a microextraction device according to claim 1 in hyphenation with a gas chromatographic column or a high-performance liquid chromatographic column.
